(19) United States
(12) Patent Application Publication
(10) Pub. No.: US 2009/0089126 A1
(43) Pub. Date: Apr. 2, 2009

(54) METHOD AND SYSTEM FOR AN AUTOMATED CORPORATE GOVERNANCE RATING SYSTEM

(76) Inventor: JIDE B. ODUBIYI, Silver Spring, MD (US)

Correspondence Address: Saul Ewing LLP (Baltimore);Attn: Patent Docket Clerk, Lockwood Place, 500 East Pratt Street, Suite 900, Baltimore, MD, 21202, US

(21) Appl. No.: 12/243,043

(22) Filed: Oct. 1, 2008

Related U.S. Application Data
(60) Provisional application No. 60/976,617, filed on Oct. 1, 2007.

(51) Int. Cl. G06Q 10/00; G06F 17/27

(52) U.S. Cl. 705/7; 704/9

(57) ABSTRACT

A method and system for developing and deploying an automated corporate governance rating software system for reducing the cost of research comprising analyzing data and generating scores. The system further comprises rating the performance of the leadership team, board of directors and executives of public and private companies. The system comprises web portals wherein a user selects a company of interest and a corporate governance score for that company is generated. The method further comprises retrieving the company's securities filings from the U.S. Securities and Exchange Commission's (SEC) database, generating the company's ratings. The method comprises domain-specific natural language questions, extracting concepts based on such a venture and automatically extracting and analyzing data to generate answers based on securities filings at the U.S. SEC. The method further comprises using over 200 corporate governance variables and an algorithm to generate corporate governance ratings and deliver them to the user via a web portal. The natural language processing involves over 2,000 industry key words and terms from the capital and financial markets, and four corporate governance categories including governance and ethics, compensation, auditing and accounting, and finance.

### FIELD OF THE INVENTION

The present invention generally relates to a method and system for developing and deploying an automated corporate governance rating software system that provides a business intelligence tool focused on rating the performance of the leadership team of public companies, including the board of directors and company executives.

### BACKGROUND OF THE INVENTION

Over the past several years, deficient corporate governance practices at some U.S. companies encouraged waste, fraud and abuse. Government, investors, market regulators and business groups required boards to improve governance practices. Many boards responded by boosting director independence and creating boardroom structures that hold management teams accountable. This widespread view that “governance matters” necessitated the creation of metrics that allowed investors to quickly and accurately identify the relative performance of companies. To meet this rising demand, companies such as Institutional Shareholder Services (ISS) and Governance Metrics International developed procedures for analyzing and rating corporate governance practices. To date, no system provides for a fully automated, consistent and accurate ratings system. Indeed, a recent study from Stanford's law and business schools underscored the poor and inconsistent results of the biggest ratings services.

The National Institutes of Science and Technology (NIST) and DARPA have sponsored the Text Retrieval Conference (TREC) and Message Understanding Conference (MUC) to provide a competitive environment for participants from the industry and academia to present solutions for selected text retrieval problems in a variety of domains. The problems of text retrieval make automation of corporate governance rating systems challenging. While a large number of participants have focused on document retrieval for named entities (e.g., locations, people's names, etc.), a few of them have demonstrated the feasibility of retrieving answers from unstructured text (Srihari & Li, 2004; Mark Greenwood, 2004, 2005; Molla & Van Zaanen, 2004; Rolf Schwitter, 2000; Ken Litkowski, 2004; & Stephen Soderland, 1999). Currently, answer extraction from open-domain text is very difficult and limited to extracting only named entities such as names, locations, etc., with a 70% success rate for retrieving correct answers for named entities (Greenwood, 2005). However, success on closed or restricted domains has been encouraging (Cunningham, 2004; Srihari & Li, 2004), although the success rate has been about the same.

Studies have shown that there is a correlation between good corporate governance and company/stock performance; therefore there is a continuing need for automated, unbiased, and consistent corporate governance rating systems to evaluate publically traded companies. There is also a continuing unmet need for a method for resolving technical challenges for automating corporate governance rating systems.

### BRIEF DESCRIPTION OF THE DRAWINGS

FIG. 1 is a depiction of a high level end-to-end process for a generic QA process applied to the present invention.

FIG. 2 is a conceptual architecture of the present invention, an automated corporate governance rating system

FIG. 3 is a diagram depicting technologies integrated into the development of this invention.

FIG. 4 depicts Parts of Speech (POS) Tagging of a Sentence to explain natural language processing.

FIG. 5 depicts Interactions among software modules to generate corporate governance ratings.

FIG. 6A is a table for Principle I: Relationship of the Board and Management and best practices in the category of Corporate Governance and Ethics Principles. The questions directed to these principles and best practices as discussed herein are depicted on the table as are answer values.

FIG. 6B is a continuation of the table of FIG. 6B for Principle I: Relationship of the Board and Management and best practices in the category of Corporate Governance and Ethics Principles. The questions directed to these principles and best practices as discussed herein are depicted on the table as are answer values.

FIG. 7 is a table for Principle II: Fulfilling the Board's Responsibilities and best practices in the category Corporate Governance and Ethics Principles. The questions directed to these principles and best practices as discussed herein are depicted on the table as are answer values.

FIG. 8 is a table for Principle III: Director Qualifications of the Board and best practices in the category of Corporate Governance and Ethics Principles. The questions directed to these principles and best practices as discussed herein are depicted on the table as are answer values.

FIG. 9 is a table for Principle IV: Role of the Nominating/Governance Committee and best practices in the category of the Board of Corporate Governance and Ethics Principles. The questions directed to these principles and best practices as discussed herein are depicted on the table as are answer values.

FIG. 10 is a table for Principle V: Evaluation of Board and CEO and best practices in the category of the Board of Corporate Governance and Ethics Principles. The questions directed to these principles and best practices as discussed herein are depicted on the table as are answer values.

FIG. 11 is a table for Principle VI: Ethics Oversight of the Board and best practices in the category of the Board of Corporate Governance and Ethics Principles. The questions directed to these principles and best practices as discussed herein are depicted on the table as are answer values.

FIG. 12 is a table for Principle VII: Hiring Special Investigative Counsel and best practices in the category of the Board of Corporate Governance and Ethics Principles. The questions directed to these principles and best practices as discussed herein are depicted on the table as are answer values.

FIG. 13 is a table for Principle VIII: Shareowner Involvement and best practices in the category of the Board of Corporate Governance and Ethics Principles. The questions directed to these principles and best practices as discussed herein are depicted on the table as are answer values.

FIG. 14 is a table for Principle IX: Long-term Share Ownership and best practices in the category of the Board of Corporate Governance and Ethics Principles. The questions directed to these principles and best practices as discussed herein are depicted on the table as are answer values.

FIG. 15 is a table for Principle X: Anti-takeover Provisions and best practices in the category of the Board of Corporate Governance and Ethics Principles. The questions directed to these principles and best practices as discussed herein are depicted on the table as are answer values.

FIG. 16 is a table for Principle I: Strong and Independent Compensation Committee and best practices in the category of Compensation. The questions directed to these principles and best practices as discussed herein are depicted on the table as are answer values.

FIG. 17 is a table for Principle II: Performance Based Compensation and best practices in the category of Compensation. The questions directed to these principles and best practices as discussed herein are depicted on the table as are answer values.

FIG. 18 is a table for Principle III: The role of Equity Based Incentives and best practices in the category of Compensation. The questions directed to these principles and best practices as discussed herein are depicted on the table as are answer values.

FIG. 19 is a table for Principle IV: Creating Long-term Focus and best practices in the category of Compensation. The questions directed to these principles and best practices as discussed herein are depicted on the table as are answer values.

FIG. 20 is a table for Principle V: Accounting Neutrality and best practices in the category of Compensation. The questions directed to these principles and best practices as discussed herein are depicted on the table as are answer values.

FIG. 21 is a table for Principle VI: Shareholder Rights and best practices in the category of Compensation. The questions directed to these principles and best practices as discussed herein are depicted on the table as are answer values.

FIG. 22 is a table for Principle VII: Transparency and Disclosure and best practices in the category of Compensation. The questions directed to these principles and best practices as discussed herein are depicted on the table as are answer values.

FIG. 23 is a table for Principle I: The Role of the Audit Committee and best practices in the category of Audit and Accounting. The questions directed to these principles and best practices as discussed herein are depicted on the table as are answer values.

FIG. 24 is a table for Principle II: Audit Committee Education and best practices in the category of Audit and Accounting. The questions directed to these principles and best practices as discussed herein are depicted on the table as are answer values.

FIG. 25 is a table for Principle III: Improving internal Controls and Internal Auditing and best practices in the category of Audit and Accounting. The questions directed to these principles and best practices as discussed herein are depicted on the table as are answer values.

FIG. 26 is a table for Principle IV: Auditor Evaluation and Rotation and best practices in the category of Audit and Accounting. The questions directed to these principles and best practices as discussed herein are depicted on the table as are answer values.

FIG. 27 is a table for Principle V: Professional Advisors and the Audit Committee and best practices in the category of Audit and Accounting. The questions directed to these principles and best practices as discussed herein are depicted on the table as are answer values.

FIG. 28 is a table for Principle VI: Services Performed by Accounting Firms and best practices in the category of Audit and Accounting. The questions directed to these principles and best practices as discussed herein are depicted on the table as are answer values.

FIG. 29 is a table for Principle I: Capital Structure and best practices in the category of Finance. The questions directed to these principles and best practices as discussed herein are depicted on the table as are answer values.

FIG. 30 is a table for Principle II: Capital Expenditures and Transactions and best practices in the category of Finance. The questions directed to these principles and best practices as discussed herein are depicted on the table as are answer values.

FIG. 31 is a table for Principle III: Treasury and Tax Matters and best practices in the category of Finance. The questions directed to these principles and best practices as discussed herein are depicted on the table as are answer values.

FIG. 32 is a table for Principle IV: Financial Transactions and best practices in the category of Finance. The questions directed to these principles and best practices as discussed herein are depicted on the table as are answer values.

### SUMMARY OF THE INVENTION

The present invention provides for a method and system for providing a corporate governance rating to publicly traded companies and organizations to a user or subscriber. The rating can be provided electronically over the Internet from the user's desktop, PDA, or a digital cell, smart phone, or other devices for receiving data as are known to those skilled in the art.

It is an object of the invention to successfully automate the generation and dissemination of corporate governance ratings to the public. The invention provides a method and system for developing and deploying an automated corporate governance rating software system for reducing the cost of research comprising analyzing data and generating scores. The system further comprises rating the performance of the leadership team, board of directors and executives of public and private companies. The system comprises web portals wherein a user selects a company of interest and a corporate governance score for that company is generated. The method further comprises retrieving the company's securities filings from the U.S. Securities and Exchange Commission's (SEC) database, generating the company's ratings. The method comprises domain-specific natural language questions, extracting concepts based on such a venture and automatically extracting and analyzing data to generate answers based on securities filings at the U.S. SEC. The method further comprises using over 200 corporate governance variables and an algorithm to generate corporate governance ratings and deliver them to the user via a web portal. The natural language processing involves over 2,000 industry key words and terms from the capital and financial markets, and four corporate governance categories including governance and ethics, compensation, auditing and accounting, and finance.

The present invention provides an effective approach to capture the user request, process it, and deliver a timely response over the Internet and provides a software program that determines the best sources to find the relevant information, including mandatory disclosure information on public companies (i.e., SEC filings) downloaded from the SEC, processed, and stored for use by the system.

The invention can forward company specific information based on user requirements, from the local SEC filings database, to the search manager software module which in turn, forwards it to a document pre-processor. These and other aspects of some exemplary embodiments will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments without departing from the spirit thereof. Additional features may be understood by referring to the accompanying drawings, which should be read in conjunction with the following detailed description and examples.

### DETAILED DESCRIPTION OF THE INVENTION

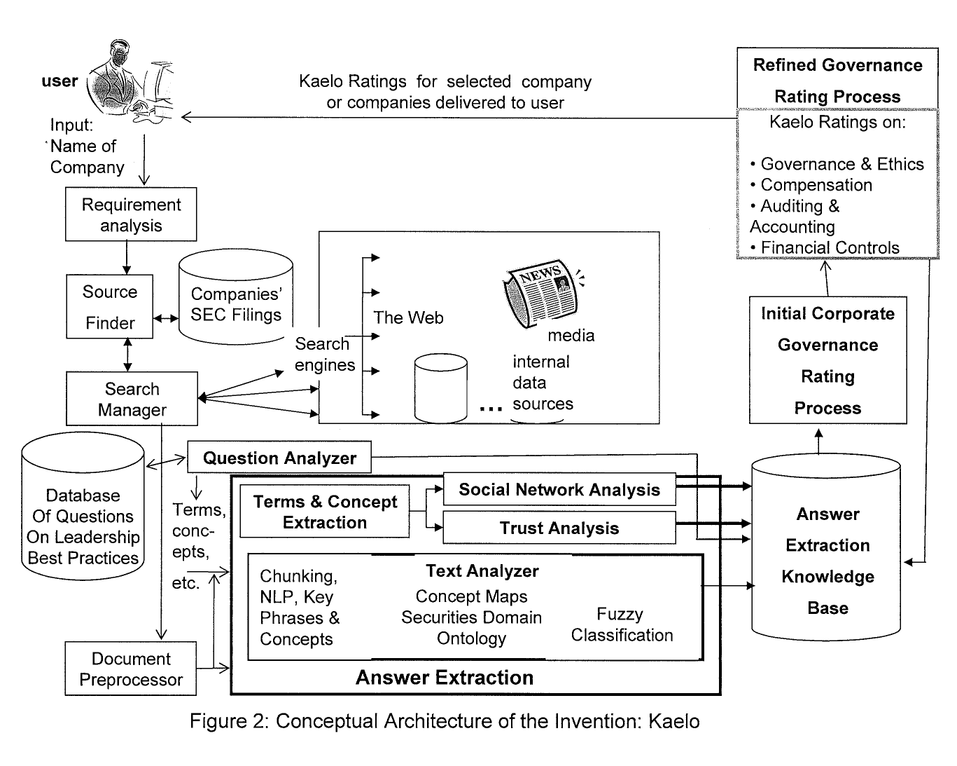

The Search Manager module initiates searches for people (i.e., additional information on members of the selected company's leadership team) and documents. This module can spawn multiple search threads, can employ multiple search engines and can probe all recommended sources including the World Wide Web as depicted in FIG. 2. The software could search the online database of the company's website (for Press Releases, and social and trust network information on the leadership team), Who's Who in Organizational leadership/Online collections of business related journal and news papers (either free or by subscription) plus general keyword searches on the web. When searching on the web, the software can invoke multiple search engines (e.g. Google, Yahoo, MSN) or Metacrawler via programmatic APIs, aggregate the first N results, and follow secondary links (optionally). The Search Manager software can pass the company name provided by the user to the Question Analysis module (i.e., the Question Analyzer in FIG. 2).

The natural language Questions database for use by the Question Analysis software (i.e. Question Analysis) can extract answers from unstructured text (e.g., SEC filings).

The Question Answering (QA) software system employs a Natural Language Processor (NLP) to parse the natural language questions stored in the questions database (i.e., a set of formulated questions for the categories of governance rating). While there are various algorithms for parsing a natural language, all algorithms have at least two things in common: a lexicon and a grammar. The parser must know the group of words and their attributes (i.e., lexicon) in a statement or question and the rules that guide the legal use of these words (i.e., grammar). For example, for a group of words such as [A, the company backdating stocks was sued of options management team] to be meaningful, the grammar rules must be applied to identify the determiner (A, the) which assists in referencing noun objects; nouns (company, stock, options, team) which describe things; adjective (management), and verbs (was, sued, backdating) which express an act. Applying the grammar requires the application of a set of rules such as sentence rules S which consist of Noun Phrases and Verb Phrases (S-˜NP VP). Noun Phrase is a combination of the Determiner (DET) and the noun (N) object: NP-˜DET N. The verb phrase combines the verb (V) and the NP: VP-V NP. The correct grammar for the group of words in the example above can be formulated as “A company was sued for backdating the options of the management team”.

The Question Analysis method processes each of the at least 200 questions to support the extraction of specific or unique answers for a specific variable. The questions in the Questions database constitute the information retrieval query that can be analyzed as a bag of words and grammar rules with a natural language processing engine.

The Document preprocessor determines the type of document (e.g. Word, PDF, HTML, etc.), formats them, and delivers them in a form that the Answer Extraction module can use to extract the answers. A text analyzer employs a natural language processing engine to process documents for use by an answer extraction system.

The challenge to obtain specific answers for restricted domain technical questions that eliminates any ambiguity in the terms or concepts extracted from the passages to support the answer (Molla & Vicedo, 2006). The questions can be rather complex and the invention decomposes and categorizes them into answer types, such as facts, location, numbers, and people.

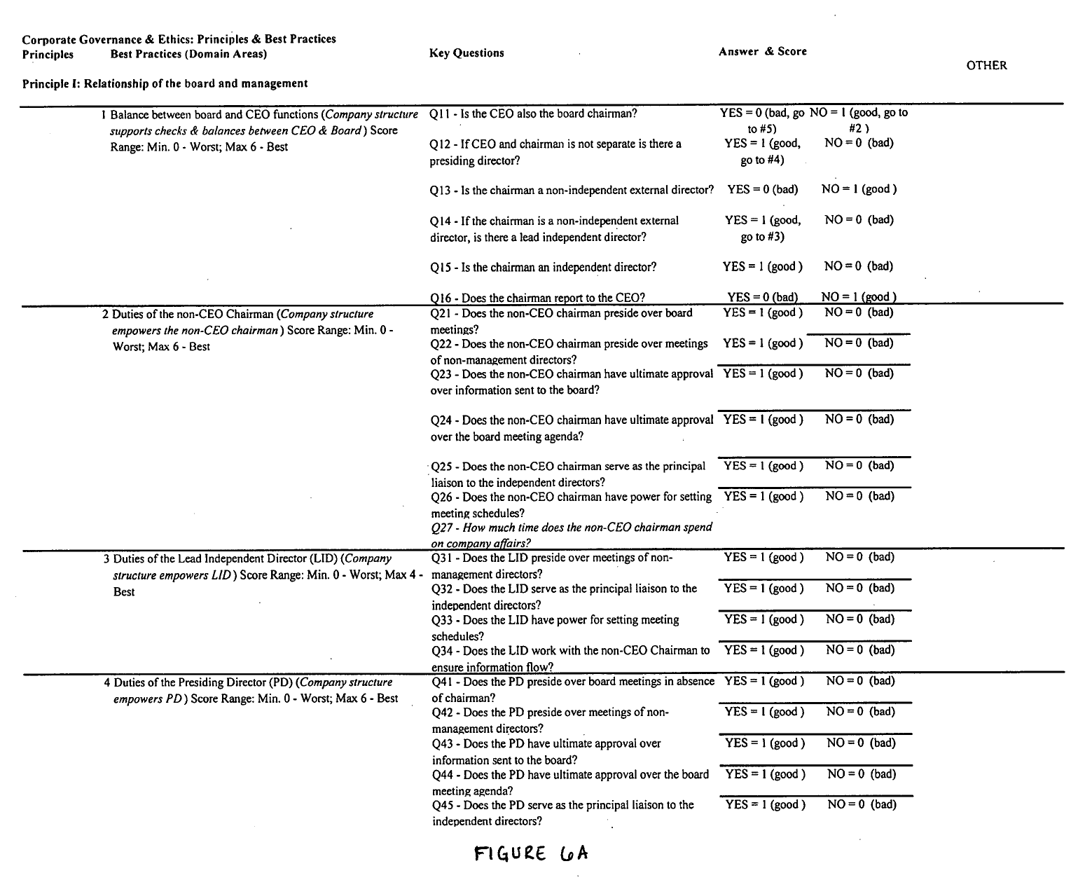

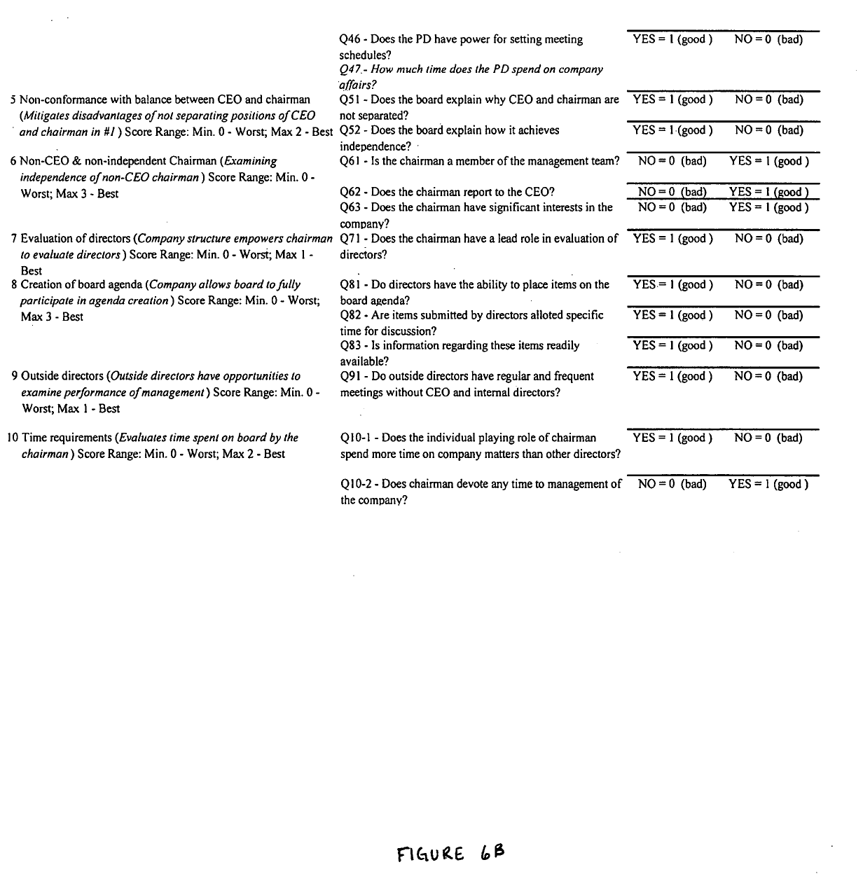

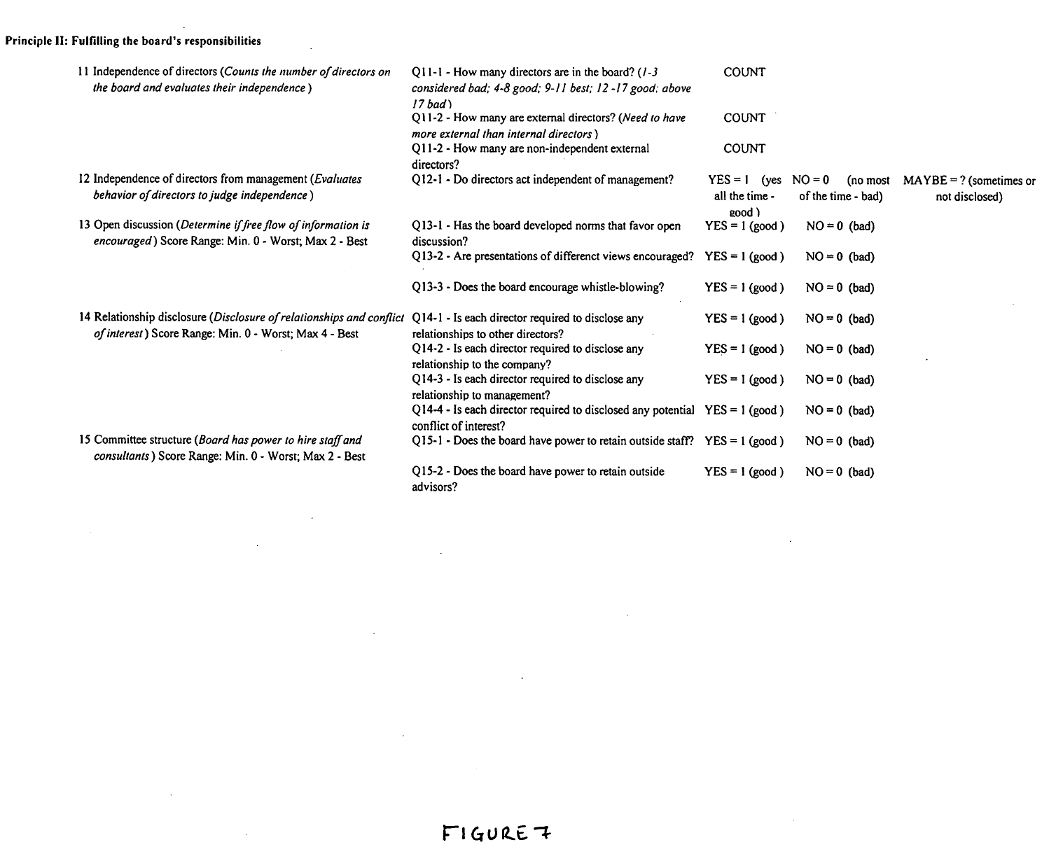

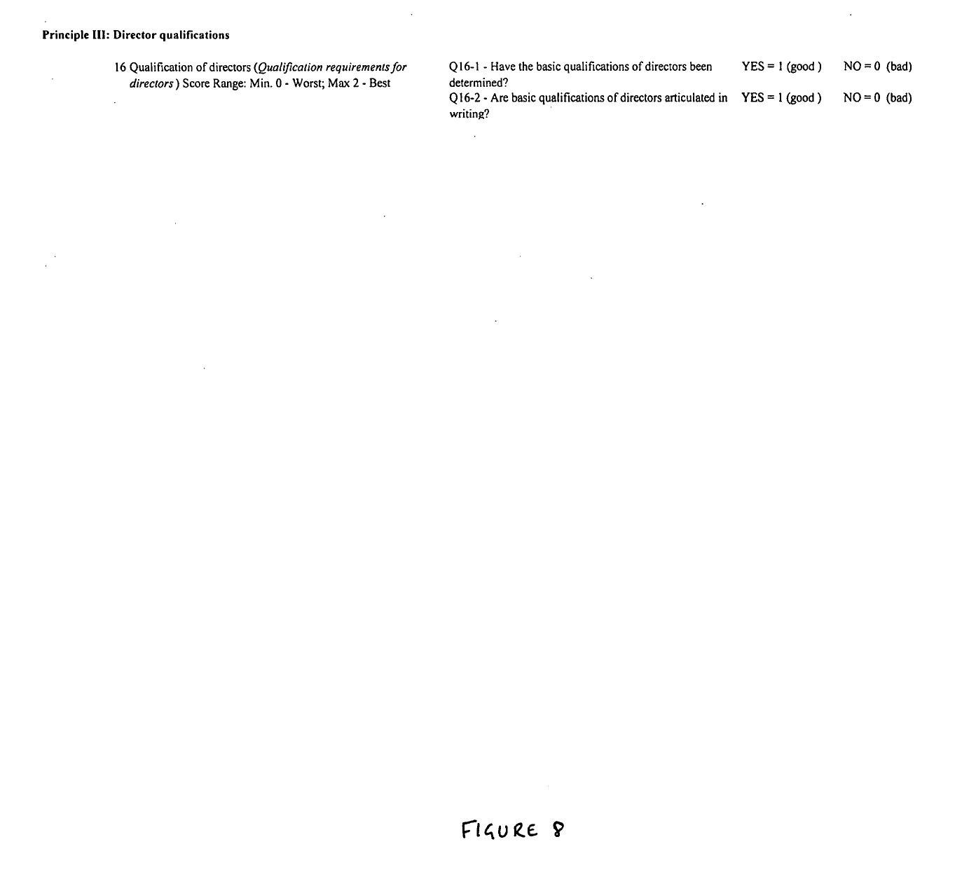

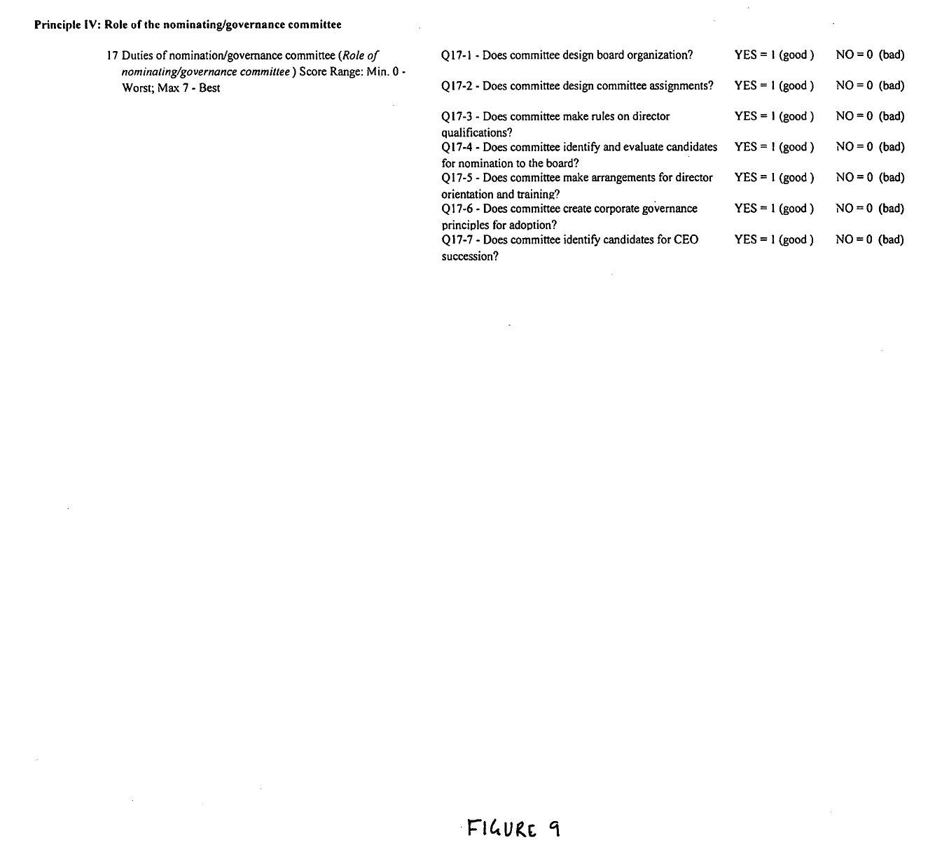

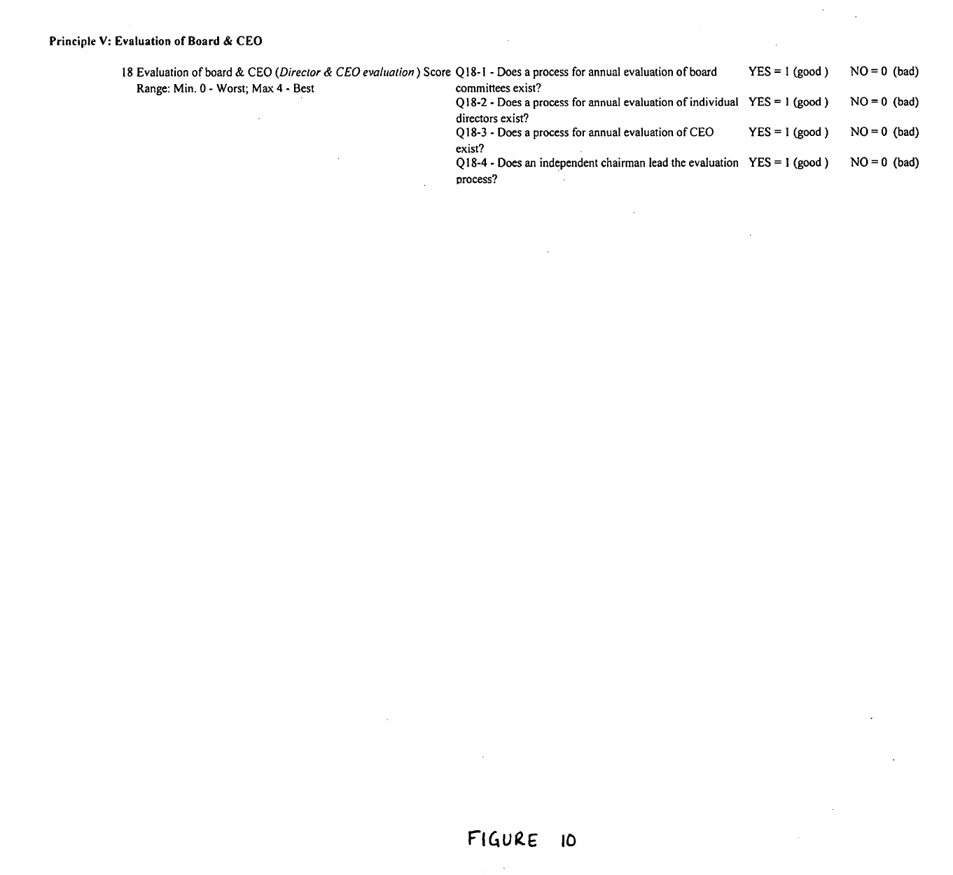

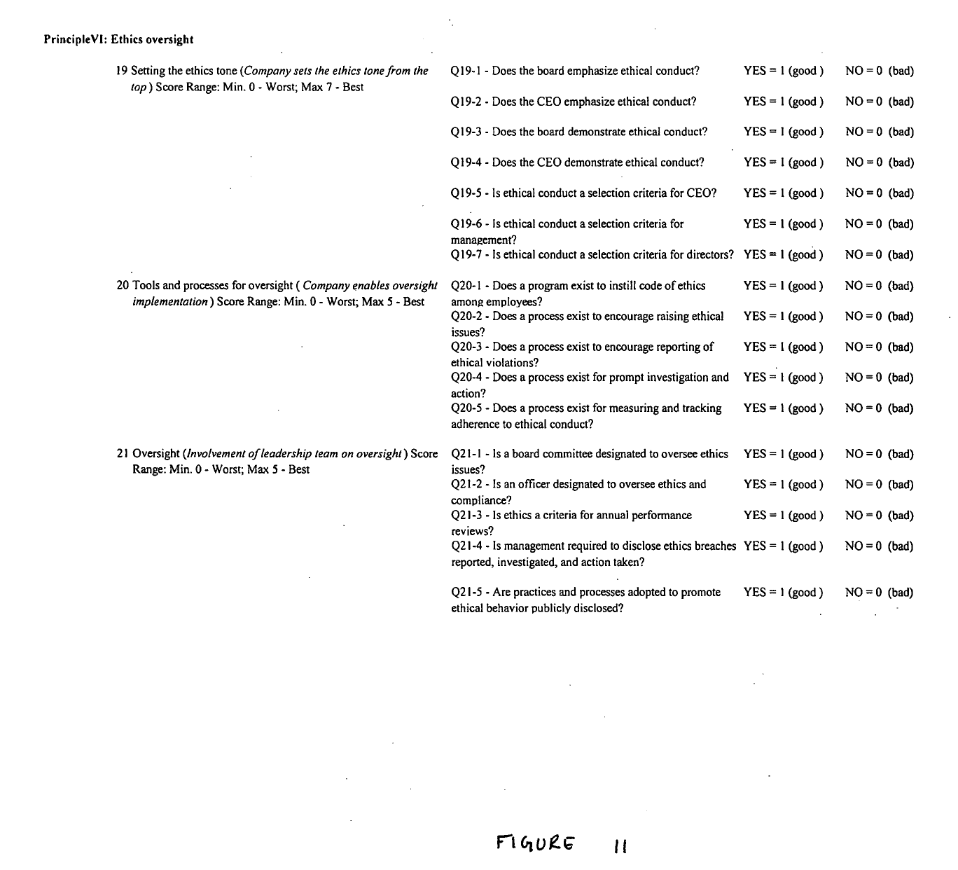

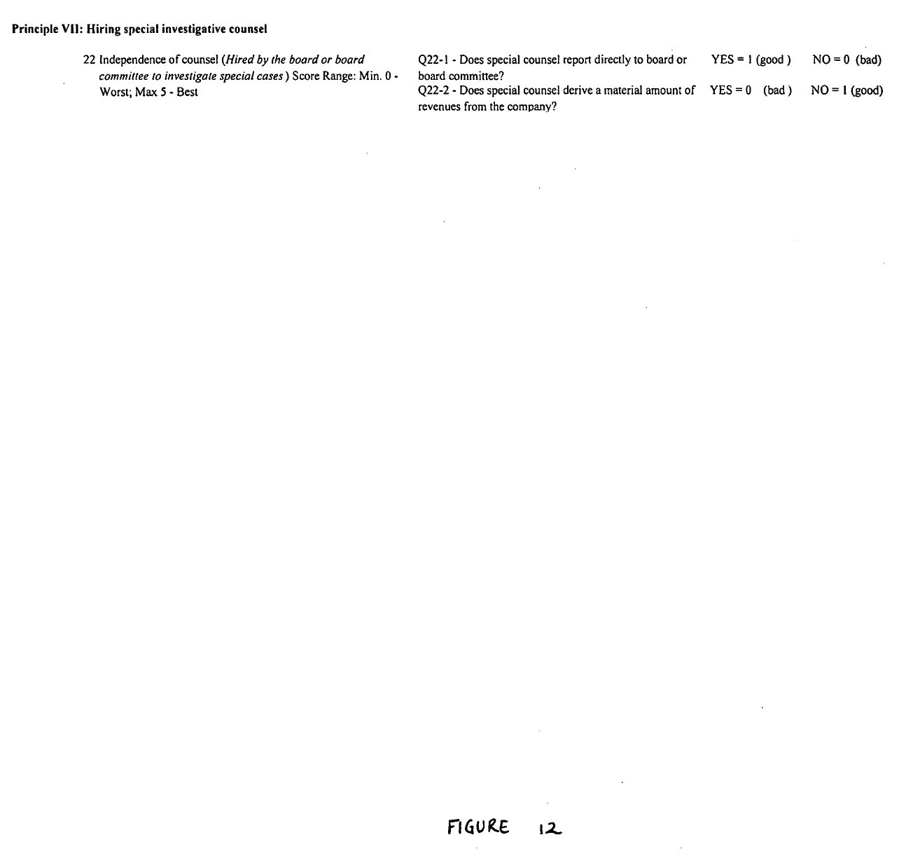

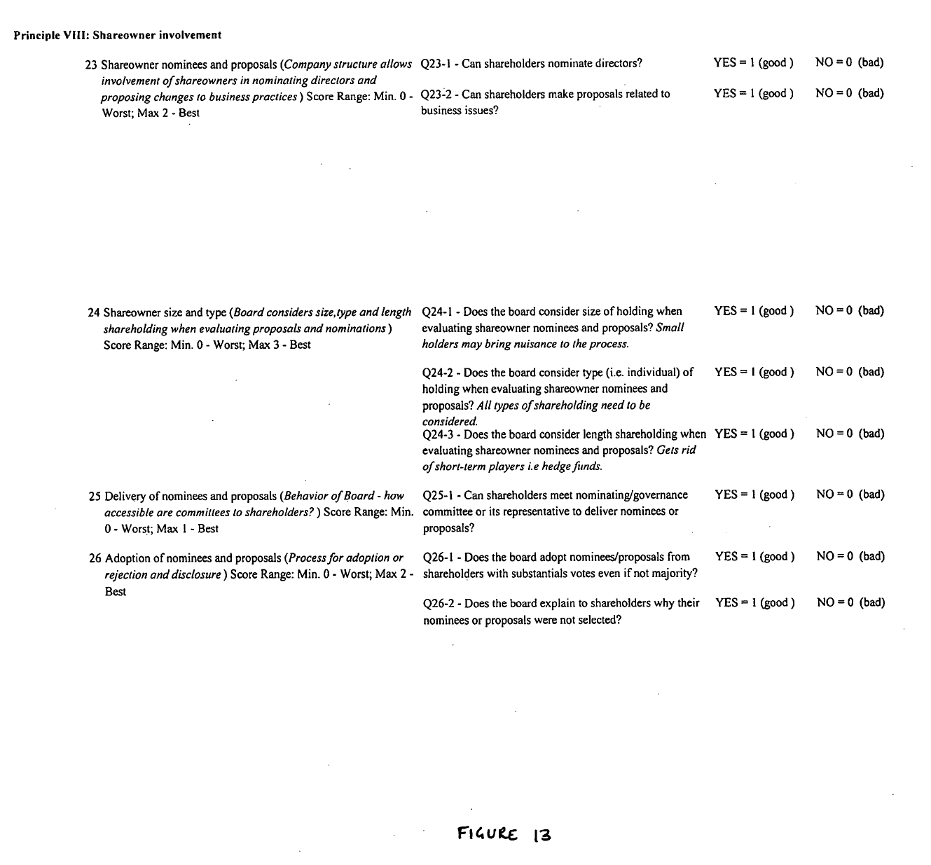

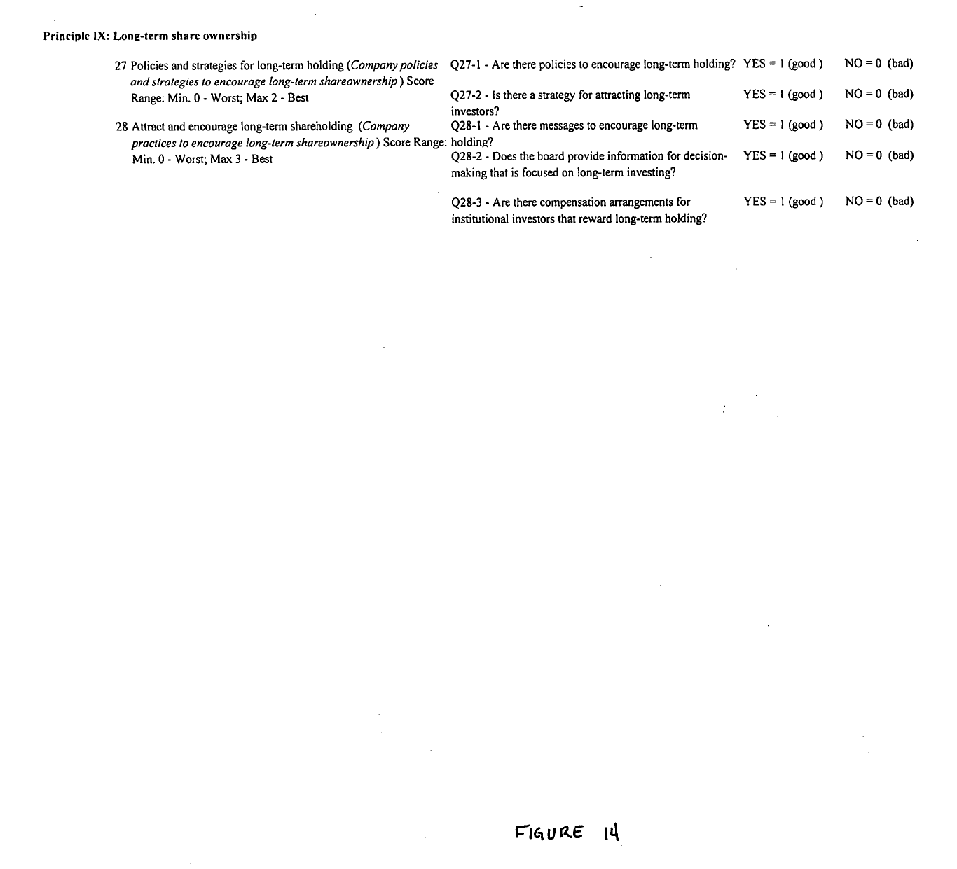

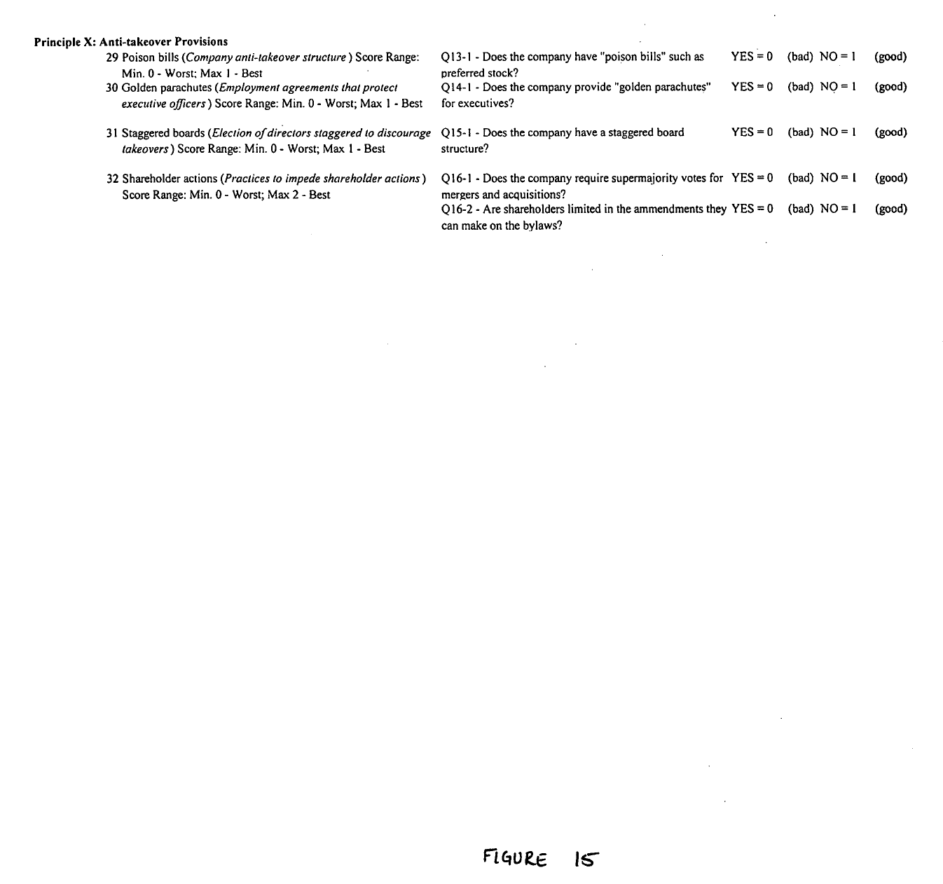

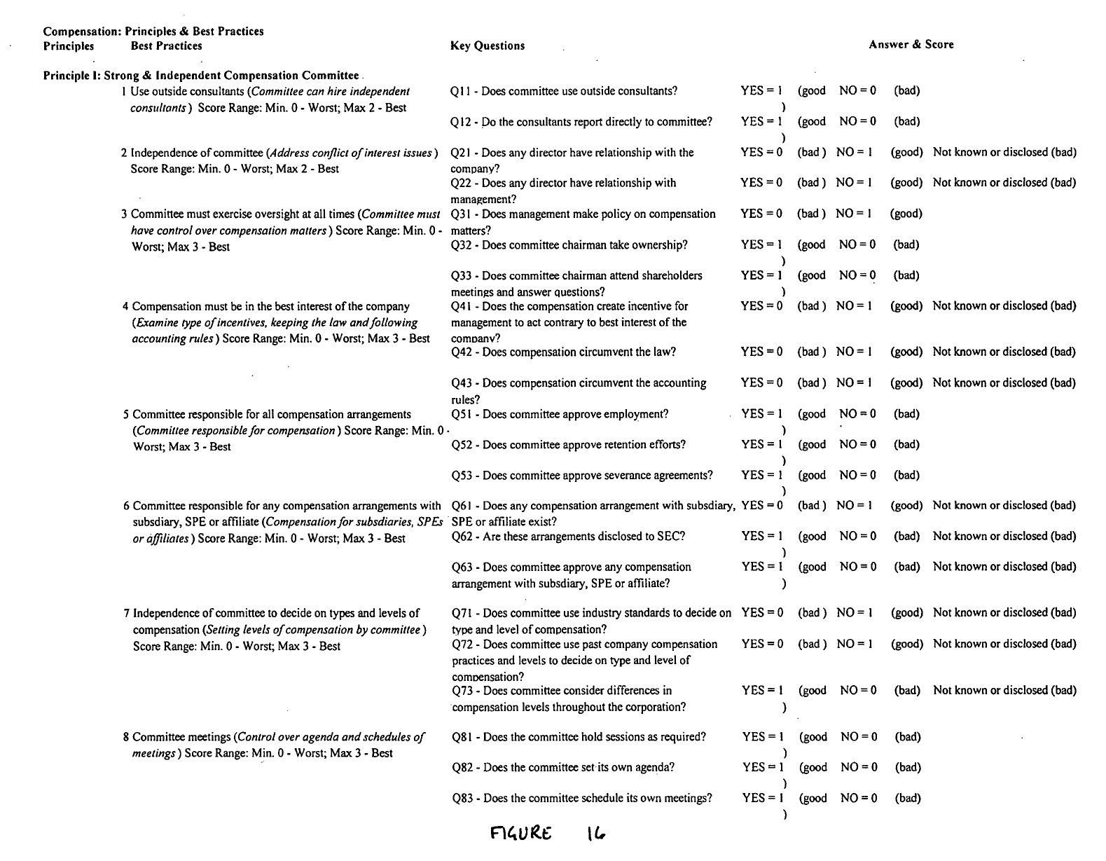

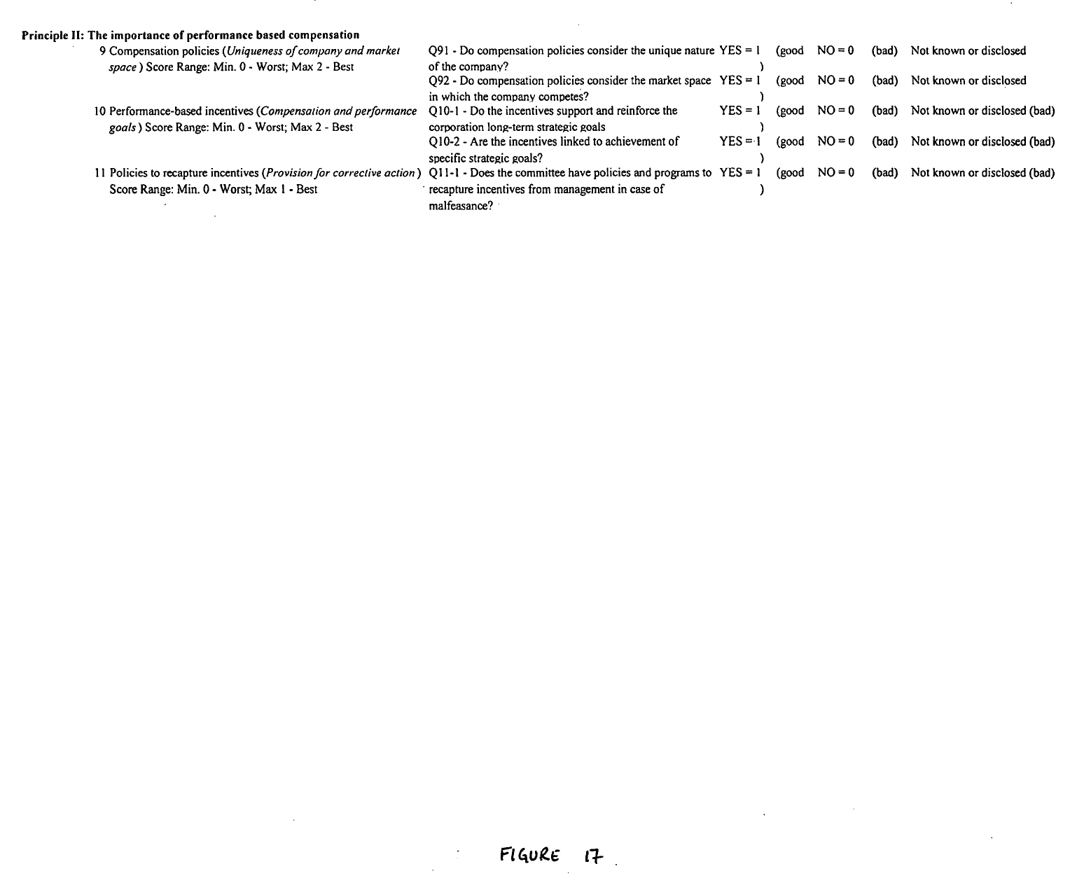

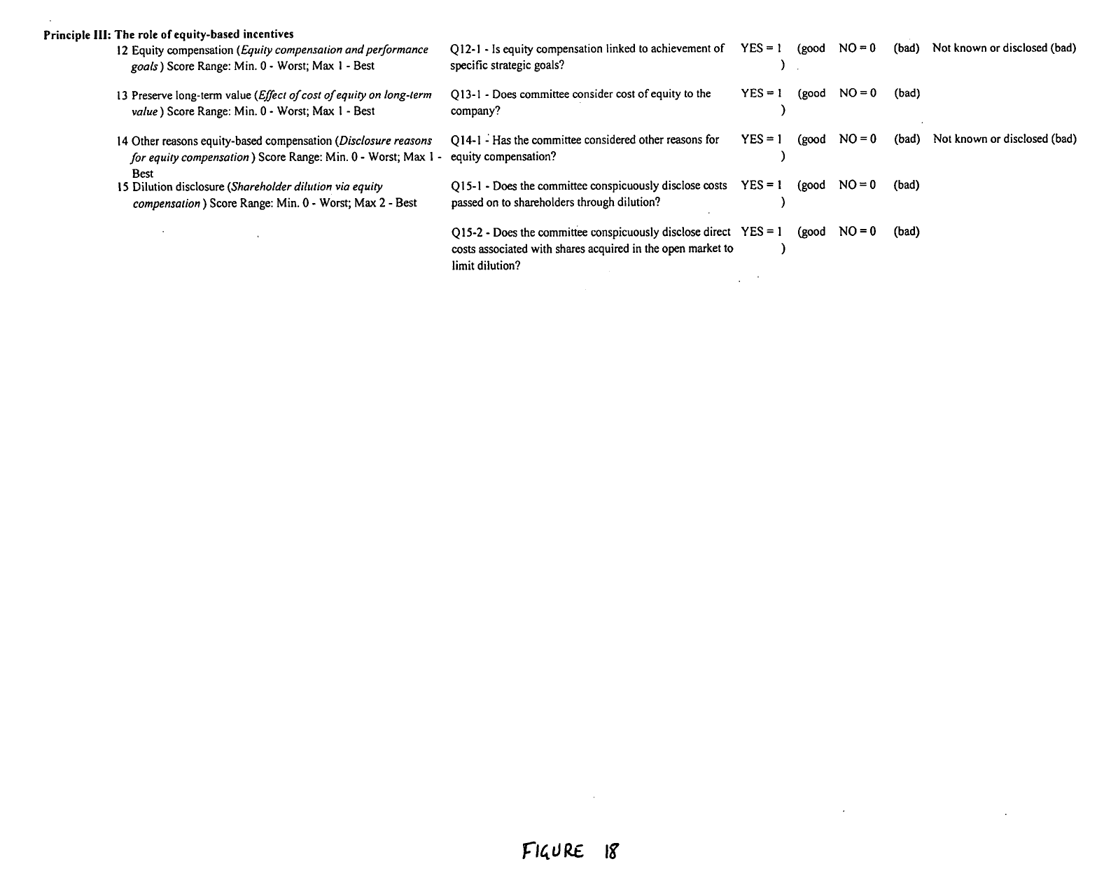

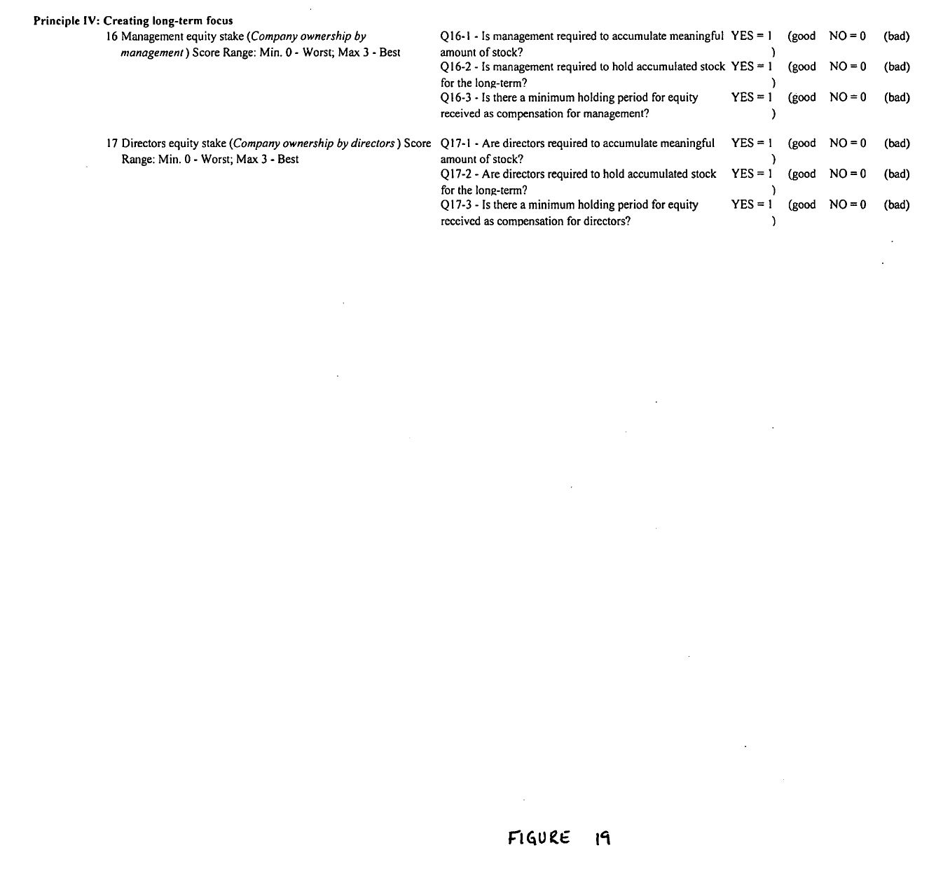

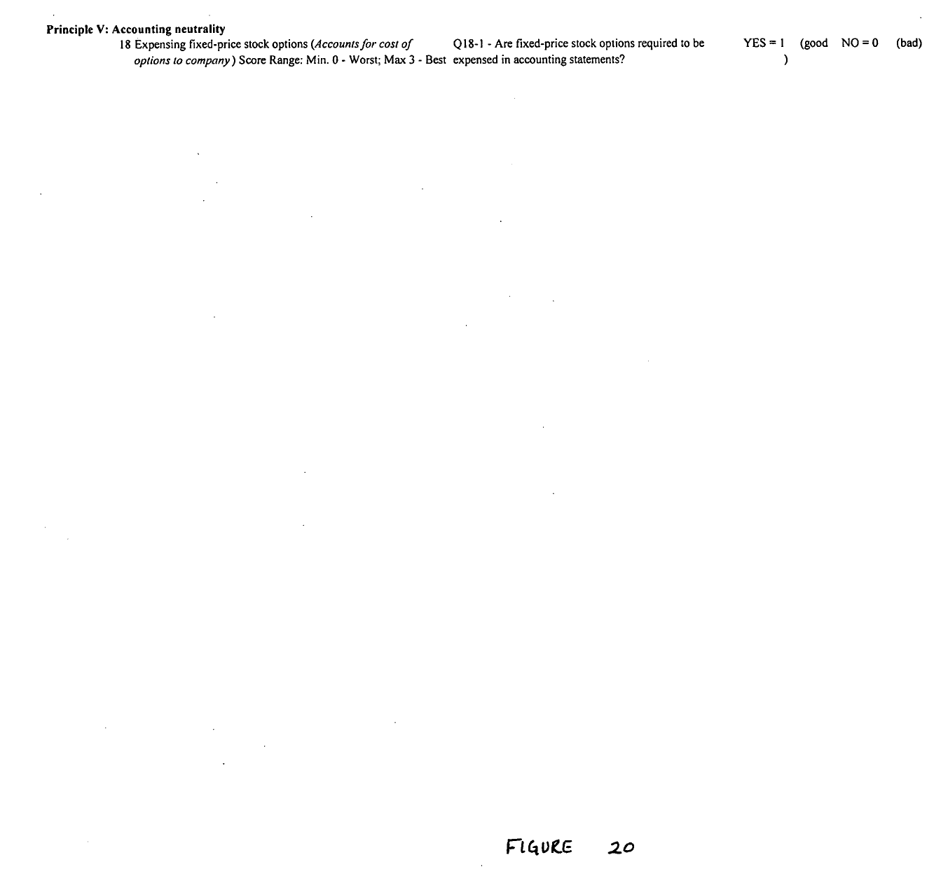

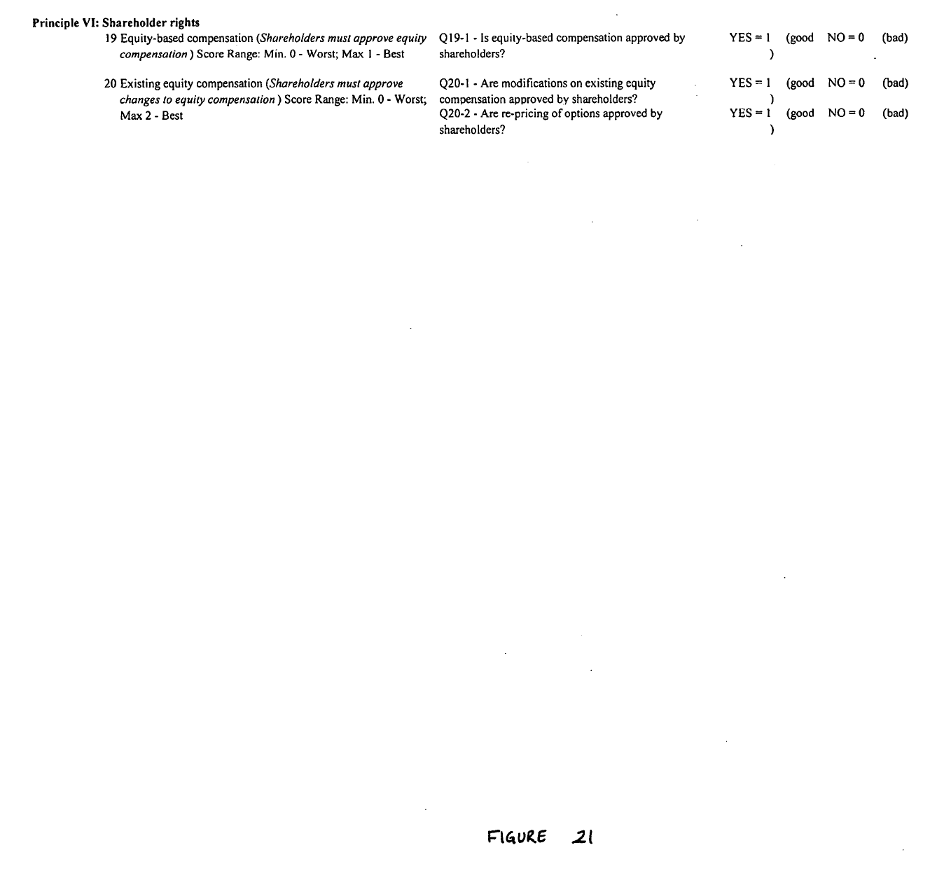

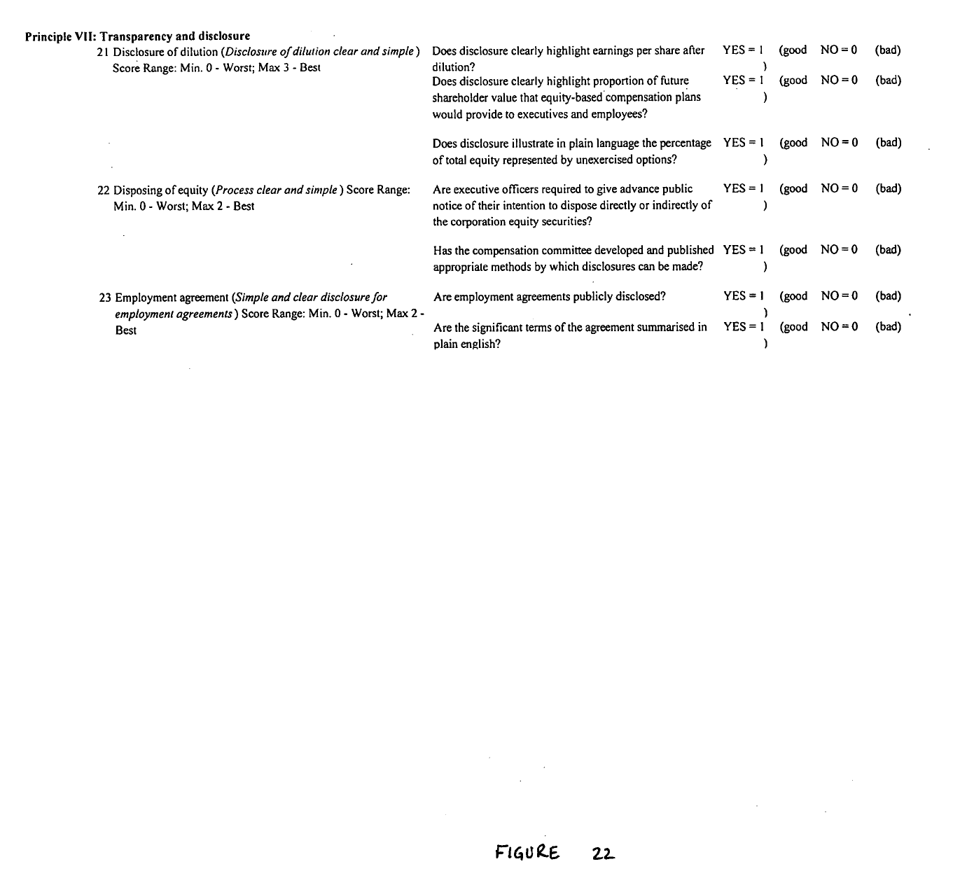

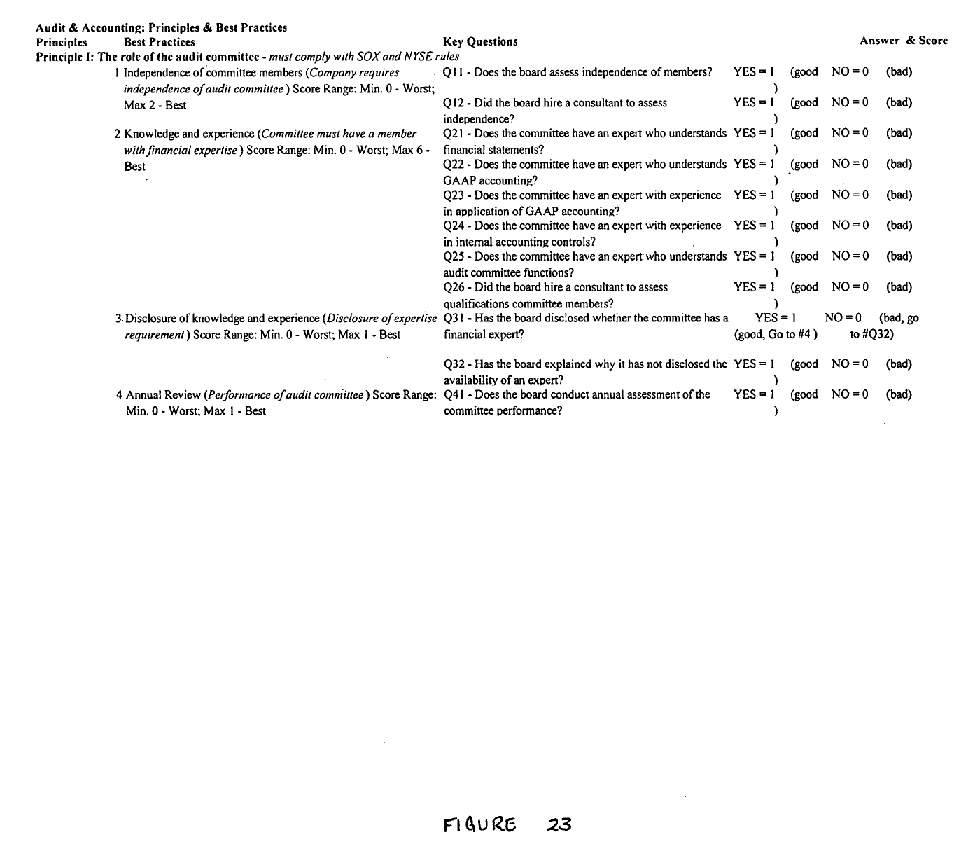

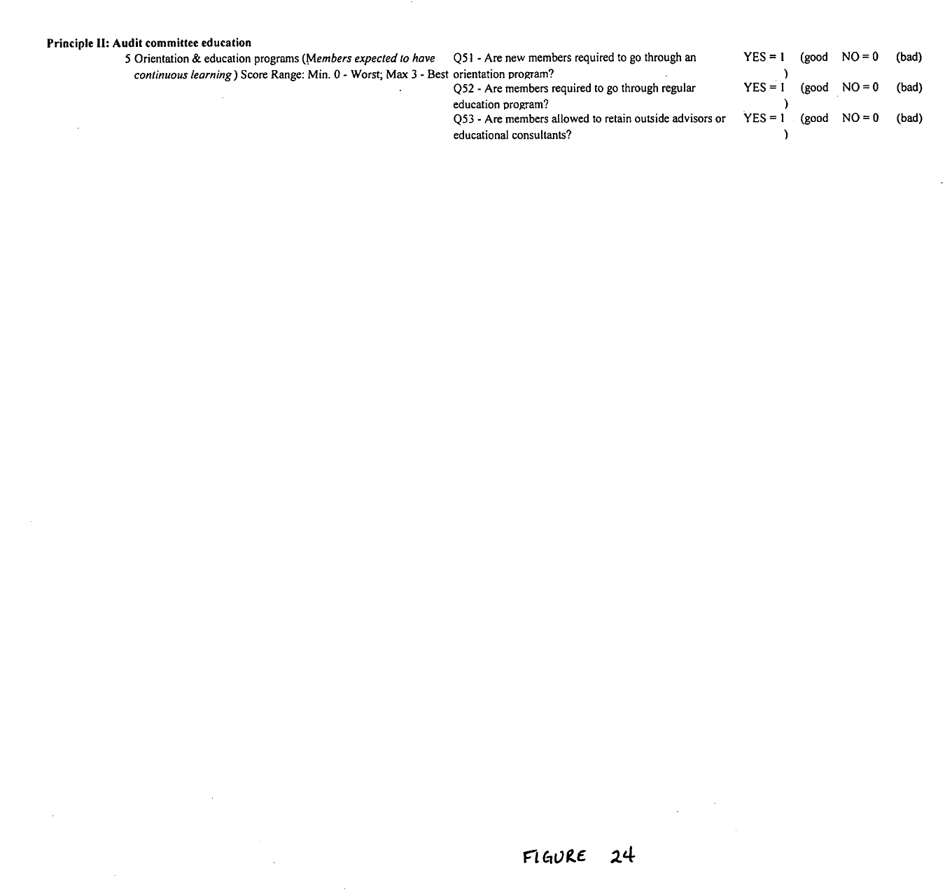

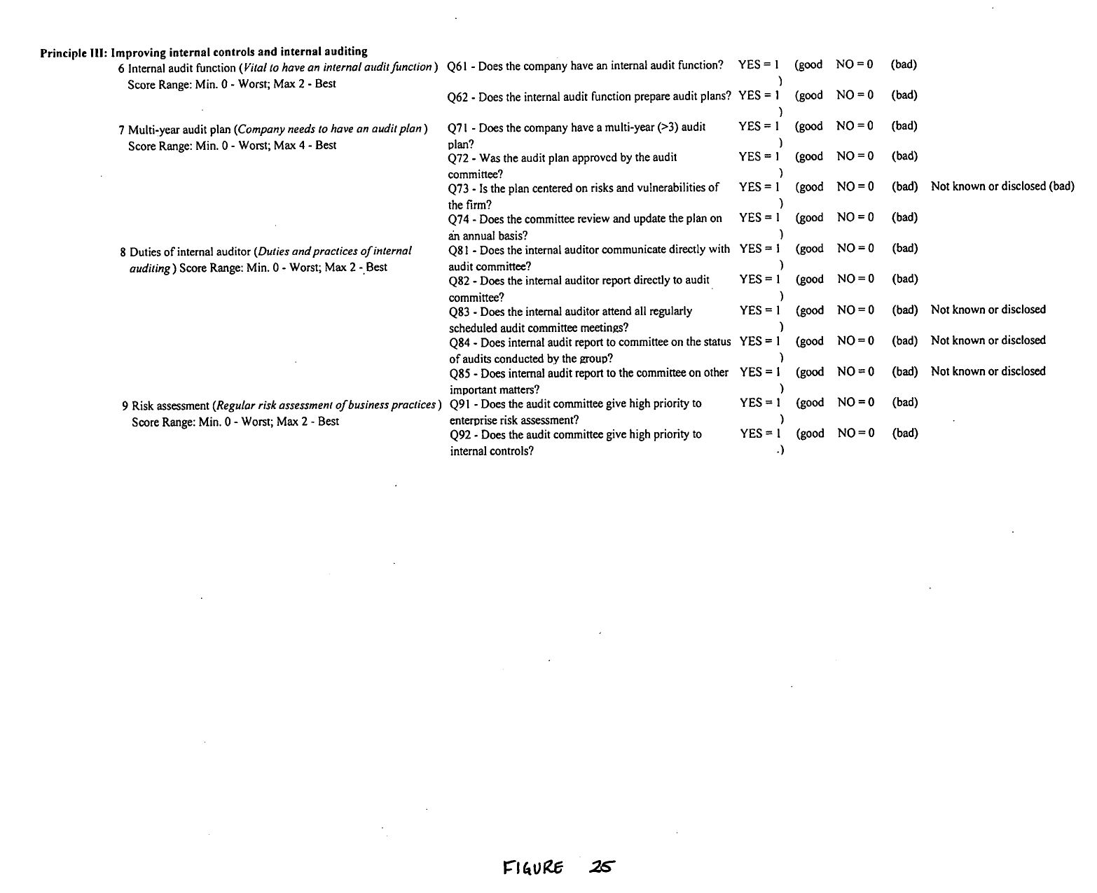

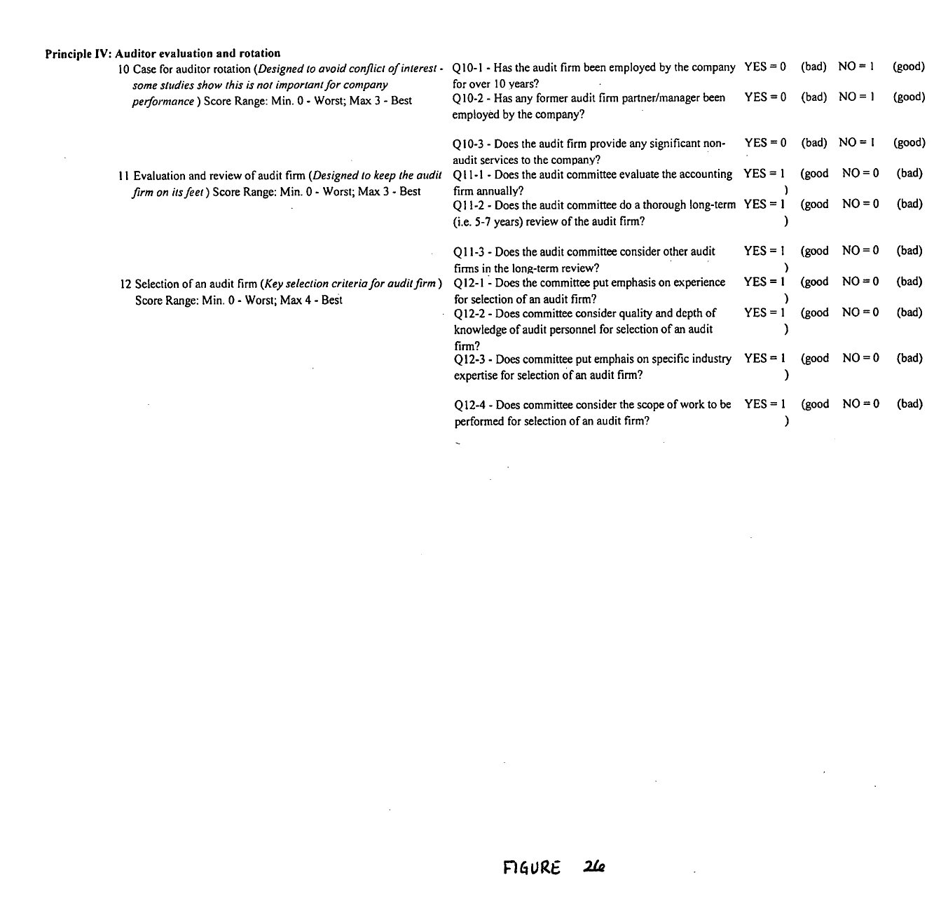

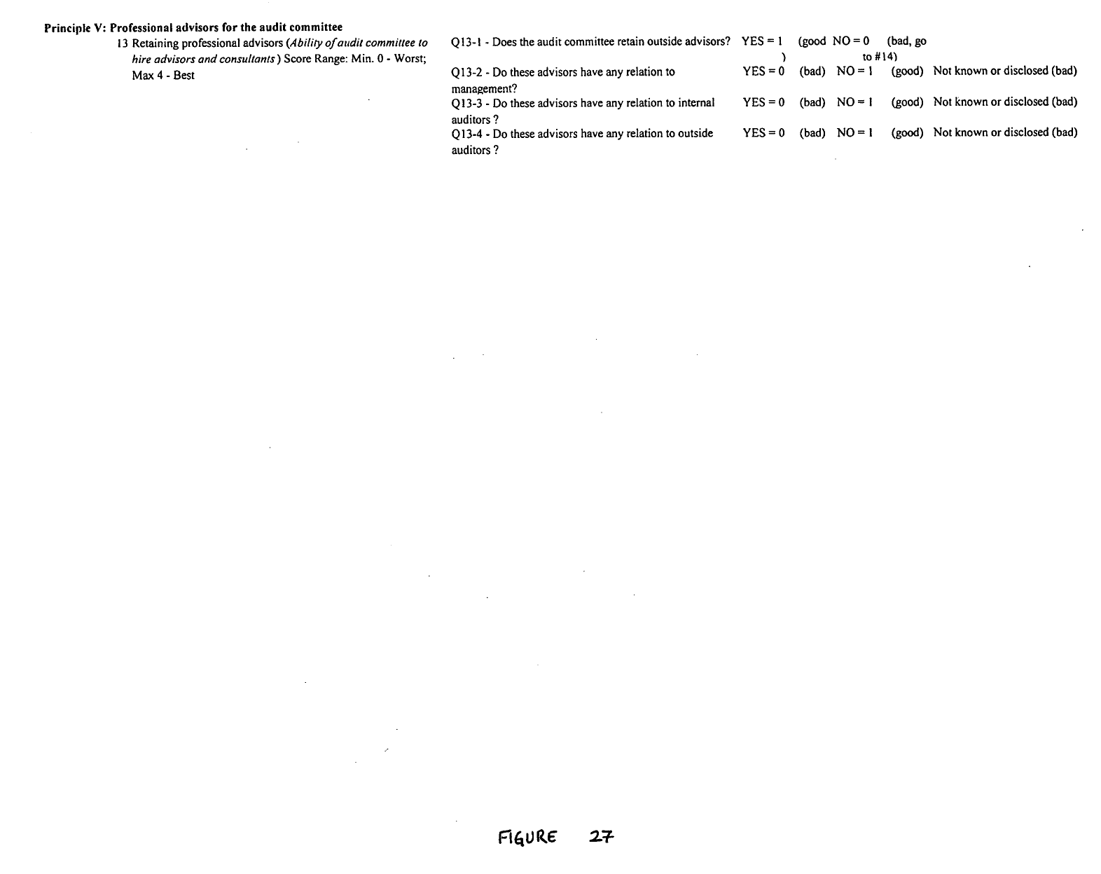

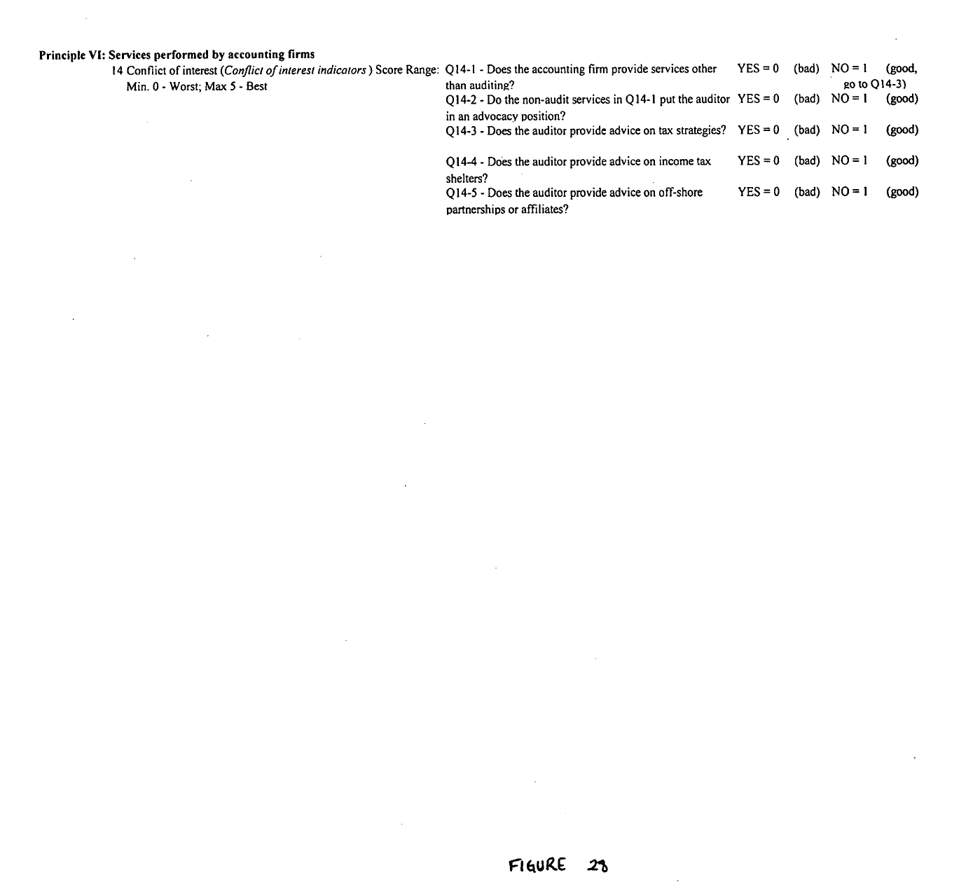

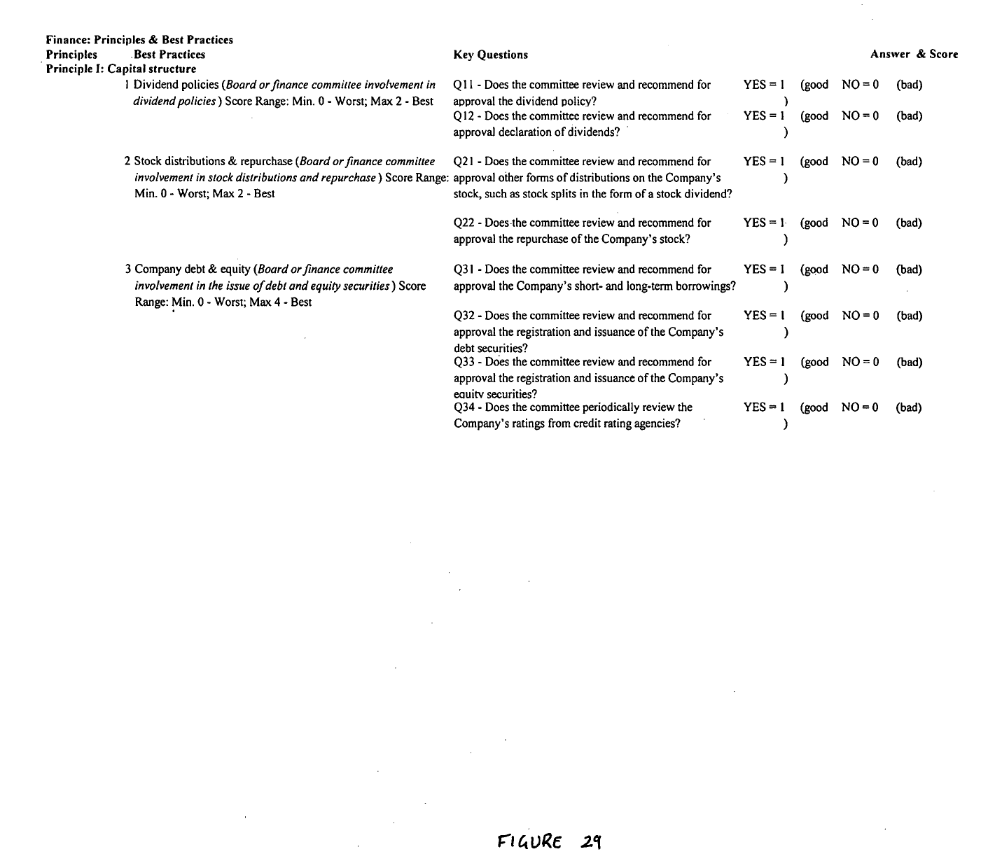

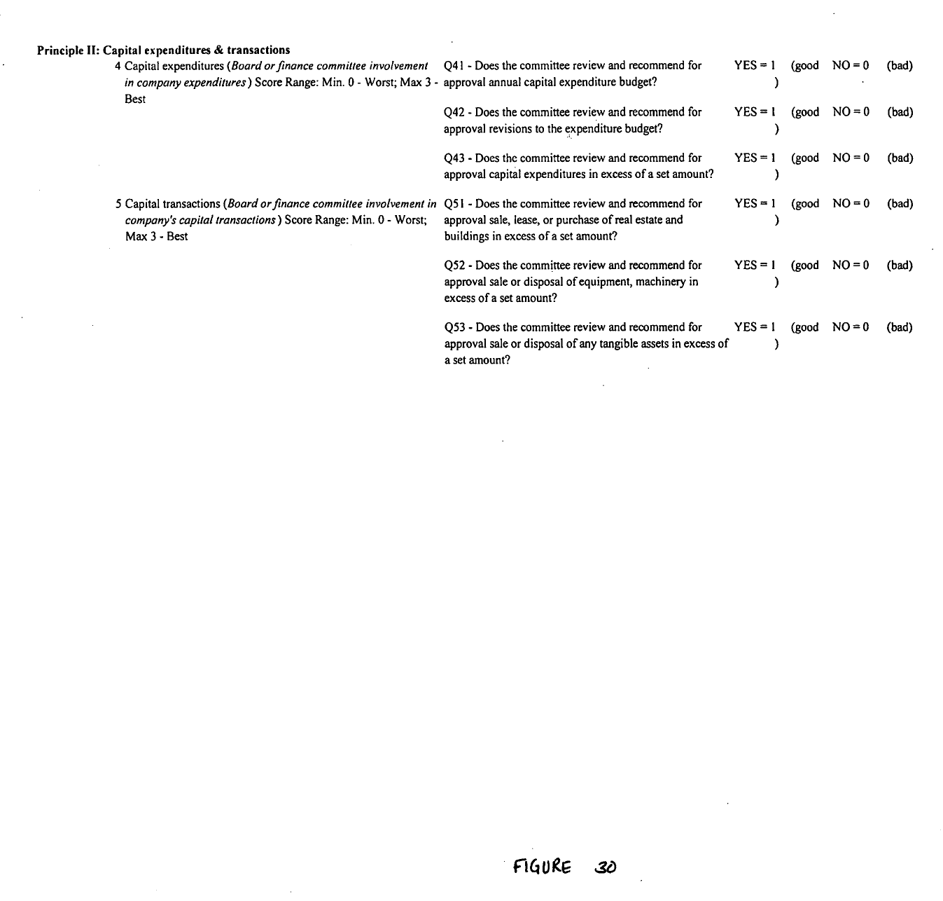

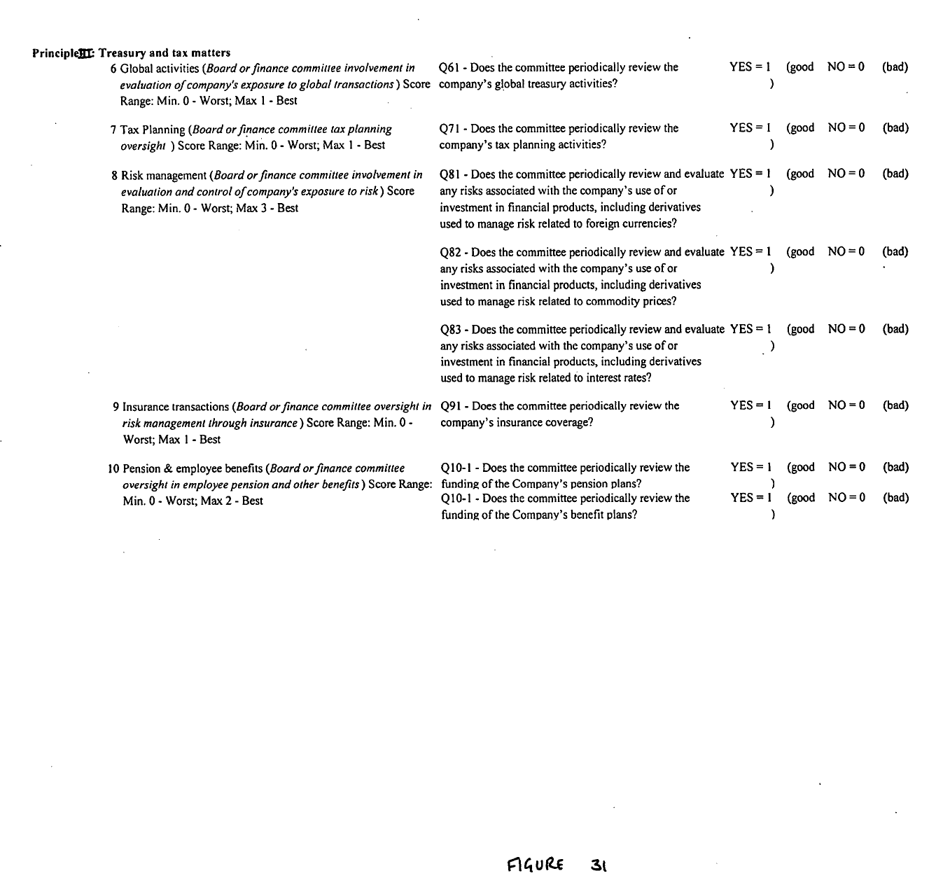

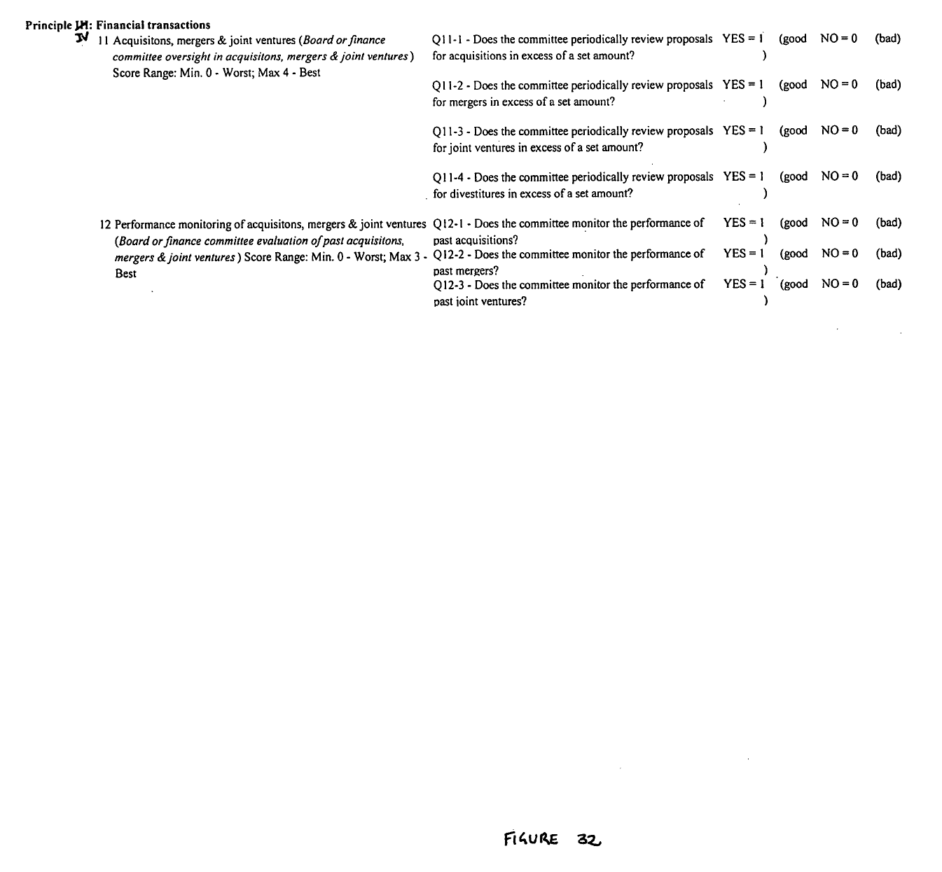

The ability to handle yes-no question for complex queries is a feature of the invention as depicted in FIG. 6 to FIG. 32. Most of the questions used to generate the governance indices are yes-no questions which are more difficult to answer than regular fact-based (i.e., factoids) or named entities (location, events, etc.) questions. To answer yes-no questions, the present invention provides for extraction and comparison of the attributes or characteristics of the entities of interest.

The invention further comprises extracting correct passages from the document (i.e., unstructured text). Inability to extract correct passages is guaranteed to lead to incorrect answers. Therefore, it is a feature of the invention to extract and validate correct passages.

The invention further comprises extracting correct answers from retrieved passages. Automatic recognition of answers in documents via a software program can be a formidable challenge, especially when considering the consequence of using incorrect answers to rate the performance of the leadership team of publicly traded companies. The use of NLP tools and the need to obtain correct answers have several technical risks that must be addressed. In particular, this approach must address the problems associated with syntactic and semantic understanding; and provides for resolution of confusion or uncertainties with the meanings of terms and concepts in the questions and unstructured text from repositories.

The invention further comprises generating initial governance rating indices using an algorithm to process the answers retrieved from an answer extraction knowledge base as depicted in FIG. 2. Also provided is a step for refining the initial governance ratings and normalizing any constraints to generate the final rating indices as depicted in FIG. 2. Experiments can be developed and run to validate the performance of the corporate governance rating system of the method and/or software. It is an object of the invention to generate accurate governance ratings for each company such that a validation step is an aspect of the invention. Thus, the system can provide accurate and reliable corporate governance rating indices that are reliable, verifiable, and on demand. This requires continuous refining and validation of the variables to improve the accuracy and reliability of the indices.

The present invention effectively and responsively delivers the indices for each company's leadership team to the user via a desktop computer connected to the Internet (for other modes of electronic delivery of data such as blue tooth as are known to those of skill in the art), a PDA, or a smart phone or other such devices as are known by those skilled in the art.

The invention provides access to the corporate governance scores through an intuitive user interface such that the user only needs to select a company of interest from a list of companies and obtain the ratings and the rationale for the scores. The method to support downloading of mandatory disclosures (e.g., public or private minable information) on public companies from the Securities and Exchange Commission (SEC); available to the public via the EDGAR database, or other publicly and/or privately available databases, and to process and store the downloaded information locally, for use by the system.

The Source Finder software system passes company specific information based on user requirements from the local SEC filings database to the search manager module which forwards it to the document pre-processor. In addition the Search Manager will initiate searches for people (i.e., additional information on members of the selected company's leadership team) and documents using a list of sources provided by the Source Finder. As shown in FIG. 2, the Search Manager can spawn multiple search threads, employ multiple search engines and probe all recommended sources including the World Wide Web. For example, it could search the online database of the company's website (for Press Releases, and social and trust network information on the leadership team), Who's Who in Organizational leadership/Online collections of business related journal and news papers (either free or by subscription) plus general keyword search on the web. When searching on the web, an advanced version of the present invention would invoke multiple search engines (e.g. Google, Yahoo, MSN, etc.) or Metacrawler via programmatic Application Programming Interfaces (APIs), aggregate the first N results, and follow secondary links (optionally).

The software and method provide for preprocessing of documents to determine the type of document (e.g. Word, PDF, HTML, etc.), and extracts the text content. Free and commercial packages, (e.g. PrimoPDF, ScanSoft PDF Converter pro, and others as are known to those skilled in the art, etc.) that can convert many formats into PDF are available, by way of example. Thereafter, it uses tools like PDFbox, an open source Java PDF library for text extraction from PDF documents and further analysis. From the raw text, the fact and concept extraction process first identifies basic parts of documents (e.g., schedule, company name, board structure, board members, audit committee, compensation committee, executive compensation, etc.) and subsequently extracts the entities for further analysis. For example, it can pass the board members' names and dates to the Social Network Analysis and Trust Analysis modules.

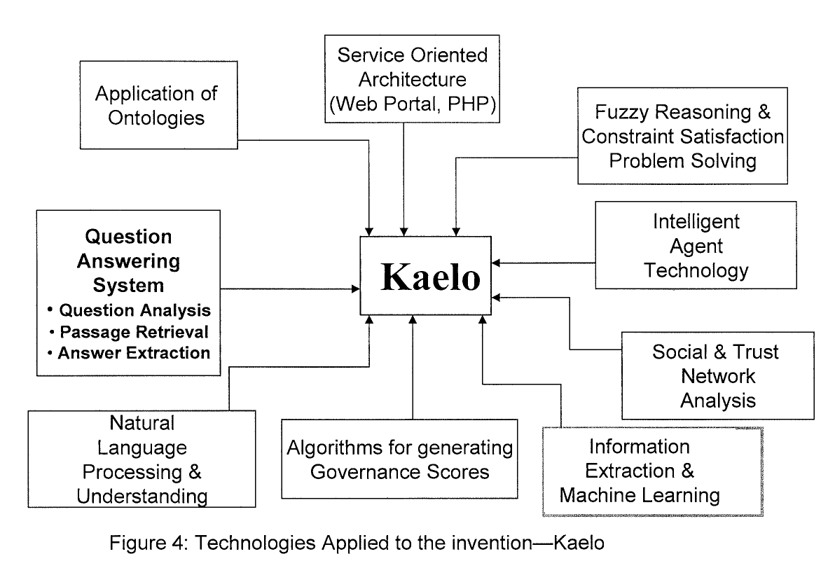

The invention employs natural language processing and understanding algorithms to support the Question Answering (QA) system. The Question Analyzer and the Answer Extraction processes uses a Natural Language Processor (NLP) to parse the questions in the questions database (i.e., a set of formulated questions for the categories of governance rating) and the sentences in the documents. Syntax refers to how the words are organized and the relationship between them. Parsing is the process of using a grammar to syntactically analyze a sentence. While there are various algorithms for parsing a natural language, all algorithms have at least two things in common: a lexicon and a grammar. The parser must know the group of words and their attributes (i.e., lexicon) in a statement or question and the rules that guide the legal use of these words (i.e., grammar). For example, for a group of words such as “the company backdating stocks was sued of options management team” to be meaningful, the grammar rules must be applied to identify the determiner (The, the) which assists in referencing noun objects; nouns (company, stock, options, team) which describe things; adjective (management), and verbs (was, sued, backdating) which express an act. Applying the grammar rules requires applying a set of rules such as sentence rules S which consist of Noun Phrases and Verb Phrases (S-3 NP VP). Noun Phrase is a combination of the Determiner (DET) and the noun (N) object: NP-DET N. The verb phrase combines the verb (V) and the NP: VP-V NP. The correct grammar for the group of words in the example above can be formulated as: The Company was sued for backdating the options of the management team, as depicted in FIG. 4.

While syntactic parsing is used to identify the words or phrases in a sentence, semantic parsing is used to identify the predicate or relation-argument structure to provide a deeper understanding of the meaning of the natural text. This system uses the NLP parser—GATE—a General Architecture for Text Engineering, an open source software developed by the University of Sheffield in the UK and available through a GNU General Public license from SourceForge to supplement any limitations of SAIRE's NLP (available in-house) and to support Text Analysis and Answer Extraction. GATE employs a very sophisticated and linguistically well grounded POS tagger—the UPenn TreeBank tagset with 48 tags (Greenwood, 2005). GATE supports the use of a rule based method to assign all possible tags to the words from a dictionary. GATE supports a version of the Common Pattern Specification Language (CPSL)—JAPE, Java Annotations Patterns Engine for recognizing character strings (regular expressions) in annotated texts. GATE also supports other critical tools needed to perform both syntactic and semantic parsing including tools for stemming, lemmatization, named entity recognition, and automatic term extraction, and text summarization. Ontologies are commonly used to support contextual analysis to check the result from semantic analysis to ensure that it makes sense to the domain.

The invention performs question analysis to categorize the questions into classes of answer types. Question analysis is the process of categorizing the questions into question classes to determine the kind of answers for each question. One approach is to identify six coarse classes of questions and about 50 fine grained classes. The six categories are Abbreviation (abbreviation, expansion); Description (definition, description, reason, etc.); Entity (currency, technique, product, etc.); Human (description, individual, title, etc.); Location (city, country, state, etc.); and Numeric (count, date, money, etc.).

The categorization can be performed manually or by using machine learning algorithms such as Decision Trees (DT), Nearest Neighbor (NN) or Support Vector Machines (SVM). In situations where the number of questions is fewer than 500, a manual approach, while more labor intensive, could provide a better classifier for open-domain QA systems. DT learning is a machine learning algorithm used to mine data from text. A tree is used to represent data and their attributes. For example, LOCATION category can be represented as the root of a tree while city, country, mountain form the branches. Each branch can form other braches such as city-name, city-population, city-size, city-age, and so on. Several samples can be used to train the tree to be robust enough so that its branches can be navigated to find the answer to a specific query about the size of a city of interest. NN algorithm is another machine learning algorithm that can be used to mine data from documents. It can be used to navigate a network of nodes to reach a destination, just as DT can be used to search for an item by navigating the branches of the tree.

Support vector machine (SVM) is also a supervised machine learning and data mining and classification algorithm. Supervised machine learning means that the algorithm must be trained with examples so that it can be used to predict a solution for a new query. For example, given data points that have been grouped into 2 classes (e.g., city-age, city-size categories), the class membership of a new data point can be determined. The class (i.e., membership) of the new data point will depend on its proximity to other data classes on a graphical plane, such that the result can be used to classify data.

For classification of question types into coarse and fine-grained classes, there are six major categories (course-grained) of question types. These categories are: ABBREVIATION, DESCRIPTION, ENTITY, HUMAN, LOCATION, and NUMERIC. The sub-categories of question types or classes are called fine-grained. For example, all questions about entities such as animal, boy, currency, disease, etc. (fine-grained elements) fall under a major category named ENTITY. On the other hand, questions about city, county, etc., fall under the category of LOCATION question [Greewood, M. A. (2005) Open-domain Question Answering].

To find relevant answers in a document, the researcher must construct the questions and classify them into appropriate categories. For example, all questions that relate to finding locations must be grouped under the LOCATION category. The process of grouping the questions types can be automated using clustering or grouping algorithms such as a statistical algorithm that can group certain entities based on the proximity of their characteristics—Nearest Neighbor (NN). Two other commonly used clustering algorithms are Decision Trees (DT) and Support Vector Machines (SVM). (Reference Greenwood, 2005).

The method can also comprise formulating at least about 200 natural language questions archived in the Questions database for use by the Question Analyzer to support the extraction of specific or unique answers for a specific variable. The questions in the Questions database constitute the information retrieval query that can be analyzed as a bag of words and grammar rules with a natural language processing engine.

In another embodiment of the invention, a dictionary can be compiled that consists of terms and concepts in the securities and capital markets domain. This dictionary can be used by the NLP embedded in the Question Analyzer to support text analysis and passage retrieval.

The method further comprises implementation and use of a hybrid passage retrieval algorithm generated from the integration of two or more passage retrieval algorithms to retrieve passages that contain relevant answers to corresponding questions. To achieve that goal, the passages retrieved for each question need to be able to provide or contribute to the answer. The hybrid passage retrieval algorithm may include the use of concept map, the SiteQ r (Tellex, et al.), and the ISI algorithm (Tellex, et al.) to connect related terms in the question with related terms in the unstructured text or document and retrieve relevant passages. The use of concept maps (directed graphs with nodes representing concepts and links representing the interrelationships) involves the process of inferring context in chunked text passages, via the use of NLP tools to identify sentence fragments, and domain ontology to resolve specialized terminology.

The invention also comprises Social Network Analysis. Through Social Network Analysis (SNA), we seek answers to questions like: Who often works with whom? Who knows what? Who are the experts? It is desirable to collect statistics on the type of relationship (e.g. peer-to-peer, or hierarchical), frequency of collaboration, affiliations, and topics of collaboration. Types of analyses for networks include line- and node-connectivity, fragmentation, density, average distance, centralization, transitivity, cliques and N-cliques.

The invention also comprises a trust network inference, which can involve analysis of social networks. Although Ding, Kolari, et al. describe trust networks as “essentially an online social network where agents are linked by trust relations”, we note that the concept of trust (and trust networks) is more complex. First, trust is associated with the level of expertise—for example, person A may trust person B to the extent that person B can reliably provide introductory/general knowledge about topic X, but not at the depth of an expert about topic X. Moreover, A may trust B very highly about topic Y, but A may distrust B about topic Z. Secondly, social ‘closeness’ is not directly related to trust. Socially, persons A and C will be ‘close’ in a network (just two-degrees of separation), but trust can not be implied between the two, although it is possible that they will trust each other. Nevertheless, even if A trusts C, it is not necessarily true that C trusts A.

The extraction of correct answers from selected passages uses NLP tools with syntactic and semantic parsers that relate terms in the questions to those in the passages. This process involves the development and use of the Text Analyzer module using the GATE NLP system as described earlier, to employ two sub modules: a) low-level natural language processing (document chunking, parts of speech (POS) tagging, keyword and phrase extraction) and b) concept mapping (employing preloaded concept maps, domain ontology, and WordNet). The Text Analyzer will also use the GATE NLP to support the five steps in Information Extraction (IE): a) Named Entity (NE) recognition to find and classify entities such as company names, locations, etc.; b) Coreference (CO) resolution to determine which entities and references (such as board chair person and company president) refer to the same person; c) Template Element (TE) construction which determines the attributes of the entities using CO, d) Template Relation (TR) construction which determines the relationships that exist between the entities of the TE; and e) the Scenario Template (ST) generation which combines the results of TE and TR to describe event scenarios or actions performed (Hamish Cunningham, 2004).

This invention uses a multi-agent system technology to model the roles, responsibilities, and social and trust networks of the leadership team of publicly traded companies. It is therefore necessary to construct a member of the board of directors' social network from a brief biographical description or structured text (e.g., tables) thereby, demonstrating social network for knowledge discovery, and storing results in the answer extraction knowledge base. Multi-agent system technology is used to model each company's committee members, their roles, responsibilities, their social networks, and role commitment violations.

The Initial Governance Rating process compares the behaviors/performance of the members of the board of directors to the industry's best practices in selected areas (e.g., corporate governance and ethics, corporate compensation, audit, and finance). This initial list is passed to the Refined Governance Rating process, where additional filters are applied to generate the final corporate governance rating indices. Several research reports (Brown & Caylor, 2004; The Conference Board Commission on Public Trust and Private Enterprise, 2003; Aggarwal & Williamson, 2006, and Gompers, Ishii, & Metrick, 2003) have documented the benefits of rating the performance of the leadership team of publicly traded company. This invention contributes to that endeavor.

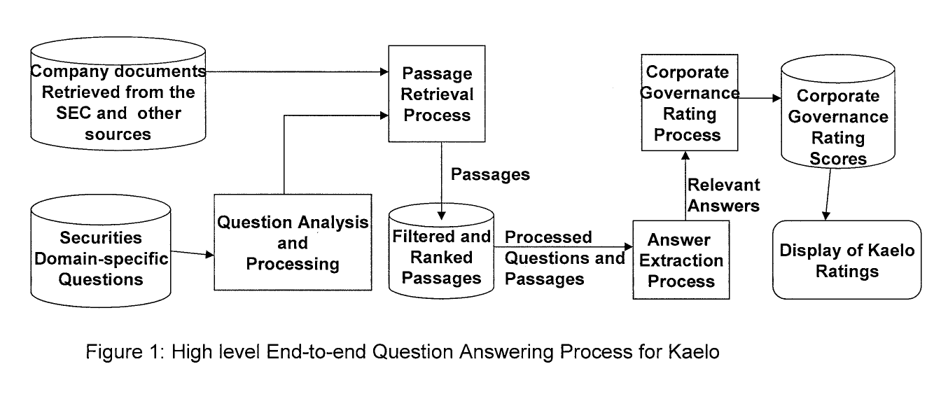

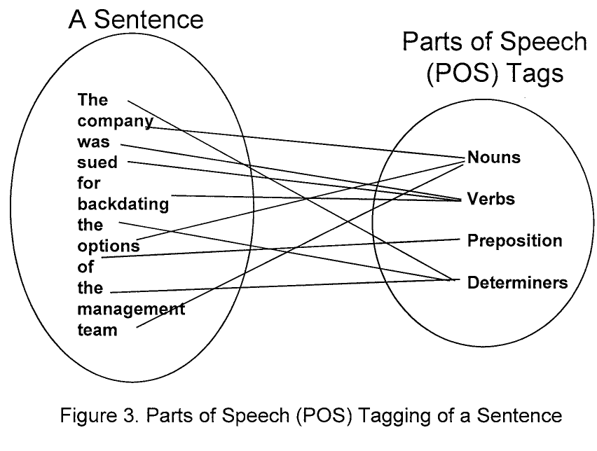

The method and system of this invention as described herein permit the user to connect to a web portal and select a company of interest from a list of companies and obtain corporate governance rating indices of the leadership team in four areas: governance and ethics, executive compensation, auditing and accounting, and finance, plus a composite score. This invention applies an automated question answering system to generate the governance indices for each company in the global 5000 corporations. One embodiment of the present invention is the high level end-to-end Question Answering process depicted in FIG. 1; another embodiment is a conceptual architecture of the system as depicted in FIG. 2, while FIG. 3 identifies the underlying technologies that need to be integrated to support the invention.

An embodiment of the invention comprises content development and integration. This step requires identifying and compiling corporate leadership principles, best practices of corporate management and variables for generating the governance ratings for a typical public company. This step also involves the selection and validation of the leadership principles, the criteria for best leadership practices and the variables on corporate governance for publicly traded companies. This step will also generate questions based on the selected variables to use in automatically extracting answers for use in generating ratings for the four corporate governance areas: governance and ethics; compensation; auditing and accounting; and finance; and the composite rating. In addition, this step involves acquisition and storage of corporate governance data for the global 5000 companies. The data sources include SEC filings from the Edgar database, company websites and other reputable datasets of newspapers, magazines and journals.

The ratings of the invention can be based on at least one, and in some embodiments four or more corporate governance areas described herein (i.e. Governance and Ethics, Compensation, Audit and Accounting, and Finance). Each of the four areas consists of a set of Principles with specific set of best practices (criteria) for each principle. A set of corresponding questions (variables) is generated for each best practice criteria. The principles for each category, their corresponding best practices are outlined below. The source of suggested corporate governance best practices is a document published by The Conference Board: Commission on Public Trust and Private Enterprise (2003) (“CONFERENCE BOARD FINDINGS”) herein incorporated by reference in its entirety.

Eight (8) principles in Executive compensation and twenty-three (23) best practices (Conference Board Findings pp 10-12), and nine (9) principles in Corporate Governance with thirty-two (32) best practices (Conference Board Findings pp 29-34) and six (6) principles in Audit and Accounting with fifteen (15) best practices (Corporate Board Findings pp 36-42) correspond to a total of seventy (70) best practices. In addition, 4 principles for Finance and 12 best practices criteria are included. The best practices criteria and the 200+ variables (questions) can be found in FIGS. 6 to 32

### Corporate Governance Principles and Best Practices

### Category 1: Corporate Governance and Ethics

### Principle I: Relationship of the Board and Management

Best Practices
1. Balance between the functions of the board and the CEO (Company structure supports checks and balances between the CEO and the Board)
2. Duties of the non-CEO Chairman (Company structure empowers the non-CEO chairman)
3. Duties of the Lead Independent Director (LID) (Company structure empowers the LID)
4. Duties of the Presiding Director (PD) (Company structure empowers the PD)
5. Non-conformance with balance between CEO and chairman (Mitigates disadvantages of not separating positions of CEO and Chairman)
6. Non-CEO and non-independent Chairman (Examining independence of non-CEO Chairman)
7. Evaluation of Directors (Company structure empowers chairman to evaluate directors)
8. Creation of board agenda (Company allows board to fully participate in agenda creation)
9. Outside directors (Outside directors have opportunities to examine performance of management)
10. Time requirements (Evaluates time spent on board by the chairman)

### Principle II: Fulfilling the Board's Responsibilities

Best Practices
11. Independence of directors (Counts the number of directors on the board and evaluates independence)
12. Independence of directors from management (Evaluates behavior of directors to judge independence)
13. Open discussion (Determine if free flow of information is encouraged)
14. Relationship disclosure (Disclosure of relationships and conflict of interest)
15. Committee structure (Board has power to hire staff and consultants)

### Principle III: Director's Qualification

16. Qualification of directors (Qualification requirements for directors)

### Principle IV: Role of the Nominating/Governance Committee

17. Duties of nominating/governance committee (Role of nominating/governance committee)

### Principle V: Evaluation of the Board and CEO

18. Evaluation of the board and CEO (Director and CEO evaluation)

### Principle VI: Ethics Oversight

19. Setting the ethics tone (Company sets the ethics tone from the top)
20. Tools and processes for oversight (Company enables oversight implementation)
21. Oversight (Involvement of leadership team on oversight)

### Principle VII: Hiring Special Investigative Counsel

22. Independence of counsel (Hired by the board or board committee to investigate special cases)

### Principle VIII: Shareowner Involvement

23. Shareowner nominees and proposals (Company structure allows involvement of shareowners in nominating directors and proposing changes to business)
24. Shareowner size and type (Board considers size, type, and length of shareholding when evaluating proposals and nominations)
25. Delivery of nominees and proposals (Behavior of Board—how accessible are committees to shareholders)
26. Adoption of nominees and proposals (Process for adoption or rejection and disclosure)

### Principle IX: Long-Term Share Ownership

27. Policies and strategies for long-term holding (Company policies and strategies to encourage long-term share ownership)
28. Attract and encourage long-term shareholding (Company practices to encourage long-term share ownership)

### Principle X: Anti-Takeover Provisions

29. Poison bills (Company anti-takeover structure)
30. Golden parachutes (Employment agreements that protect executive officers)
31. Staggered boards (Election of directors staggered to discourage takeovers)
32. Shareholder actions (Practices to impede shareholder actions)

### Category 2: Compensation—Principles and Best Practices

### Principle I: Strong and Independent Compensation Committee

1. Use outside consultants (Committee can hire independent consultants)
2. Independence of committee (Address conflict of interest issues)
3. Committee must exercise oversight at all times (Committee must have control over compensation matters)
4. Compensation must be in the best interest of the company (Examine type of incentives, keeping the law and following accounting rules)
5. Committee is responsible for all compensation arrangements with subsidiary or affiliate (Compensation for subsidiaries or affiliates)
6. Committee is responsible for any compensation arrangements with subsidiaries or affiliates (Compensation for subsidiaries or affiliates)
7. Independence of committee to decide on types and levels of compensation (Setting levels of compensation by committee)
8. Committee meetings (Control over agenda and schedules of meetings)

### Principle II: The Importance of Performance Based Compensation

9. Compensation policies (Uniqueness of company and market space)
10. Performance-based incentives (Compensation and performance goals)
11. Policies to recapture incentives (Provision for corrective action)

### Principle III: The Role of Equity-Based Incentives

12. Equity compensation (Equity compensation and performance goals)
13. Preserve long-term value (Effect of cost of equity on long-term value)
14. Other reasons for equity-based compensation (Disclosure reasons for equity-based compensation)
15. Dilution disclosure (Shareholder dilution via equity compensation)

### Principle IV: Creating Long-Term Focus

16. Management equity stake (Company ownership by management)
17. Directors equity stake (Company ownership by directors)

### Principle V: Accounting Neutrality

18. Expensing fixed-price stock options (Accounts for cost of options to company)

### Principle VI: Shareholder Rights

19. Equity-based compensation (Shareholders must approve equity compensation)
20. Existing equity compensation (Shareholders must approve changes to equity compensation)

### Principle VII: Transparency and Disclosure

21. Disclosure of dilution (Disclosure of dilution is clear and simple)
22. Disposing of equity (Process is clear and simple)
23. Employment agreement (Simple and clear disclosure for employment agreements)

### Category 3: Audit and Accounting: Principles and Best Practices

Principle I: The Role of the Audit Committee—Must Comply with SOX and NYSE Rules
1. Independence of committee members (Company requires independence of audit committee)
2. Knowledge and experience (Committee must have a member with financial expertise)
3. Disclosure of knowledge and experience (Disclosure of expertise requirement)
4. Annual review (Performance of audit committee)

### Principle II: Audit Committee Education

5. Orientation and education programs (Members expected to have continuous learning)

### Principle III: Improving Internal Controls and Internal Auditing

6. Internal audit function (Vital to have an internal audit function)
7. Multi-year audit plan (Company needs to have an audit plan)
8. Duties of internal auditor (Duties and practices of internal auditing)
9. Risk assessment (Regular risk assessment of business practices)

### Principle IV: Auditor Evaluation and Rotation

10. Case for auditor rotation (Designed to avoid conflict of interest—some studies show this is not important for company performance)
11. Evaluation and review of audit firm (Designed to keep the audit firm on its feet)
12. Selection of an audit firm (Key selection criteria for audit firm)

### Principle V: Professional Advisors for the Audit Committee

13. Retaining professional advisors (Ability of audit committee to hire advisors and consultants)

### Principle VI: Services Performed by Accounting Firms

14. Conflict of interest (Conflict of interest indicators)

### Category 4: Finance: Principles and Best Practices

### Principle I: Capital Structure

1. Dividend policies (Board or finance committee involvement in dividend policies)
2. Stock distributions and repurchase (Board or finance committee involvement in stock distributions and repurchase)
3. Company debt and equity (Board or finance committee involvement in the issue of debt and equity securities)

### Principle II: Capital Expenditures and Transactions

4. Capital expenditures (Board or finance committee involvement in company expenditures)
5. Capital transactions (Board or finance committee involvement in company's capital transactions)

### Principle II: Treasury and Tax Matters

6. Global activities (Board or finance committee involvement in evaluation of company's exposure to global transactions)
7. Tax planning (Board or finance committee tax planning oversight)
8. Risk management (Board or finance committee involvement in evaluation and control of company's exposure to risk)
9. Insurance transactions (Board or finance committee oversight in risk management through insurance)
10. Pension and employee benefits (Board or finance committee oversight in employee pension and other benefits)

### Principle III: Financial Transactions

11. Acquisitions, mergers, and joint ventures (Board or finance committee oversight in acquisitions, mergers and joint ventures)
12. Performance monitoring of acquisitions, mergers and joint ventures (Board or finance committee evaluation of past acquisitions, mergers and joint ventures)

The software and method can further comprise question processing, development, and application of a smart Source Finder. The three subtasks of the Source Finder include adapting the Natural Language Processing (NLP) tools and use them to process the question; acquiring or developing and applying a smart Source Finder. Once topics of interests are specified, the subtask focuses on developing an autonomous agent software program that will determine and visit a complete list of candidate data sources, with the aid of the Search Manager process, determine the best subset, and maintain an up-to-date knowledge base of sources and their content descriptions. In the domain of the leadership team (i.e., the boards of directors of companies), in addition to SEC filings stored locally, the sources of information on the leadership team include the company's website, especially, investor relations menu, filings at the SEC, online publications, news papers, and business related magazines and journals; and testing and documenting the results.

The present software and method comprises implementation and application of passage retrieval algorithms to retrieve document passages or sentences that provide or contribute to obtaining relevant answers. This method employs a hybrid passage retrieval strategy; a combination of the SiteQ Scorer (Tellex, et al., 2003) algorithm, the ISI passage retrieval algorithm (Tellex, et al., 2003), and Kaelo weighted-concept and query-directed passage extraction method as explained in the following sentences. The SiteQ Scorer computes the score of a retrieved passage by tallying the number of query terms that appear within the passage and the question. The algorithm assigns weights to the retrieved passages and those passages in which the query terms are closer carry higher weights. The ISI passage retrieval algorithm weights passages based on the similarity of the terms within each passage to corresponding questions. It can assign weights to proper names, terms, and stemmed words that match exactly to the words in the query. Kaelo weighted-concept query-directed passage extraction method weights the concepts within each question and retrieves and ranks relevant passages based on question-specific syn-sets (synonym sets).

Concept map techniques can be used to connect related terms in the question with related terms in the text. We will investigate the use of Natural Language Processing (NLP) tools and WordNet. Simple Term Frequency-Inverse Document Frequency (TF-IDF) which assigns weights to each term (i.e., word) and keyword matching between desired information and available content have produced some useful applications, but all have limitations due to semantic and context ignorance. The use of concept maps (directed graphs with nodes representing concepts and links representing the interrelationships) to infer context in chunked text passages will be demonstrated, via the use of NLP tools to identify sentence fragments, domain ontology to resolve specialized terminology, WordNet for generic synonyms, and clues from annotated metadata or XML tags when available.

Also comprised as part of the software and method is the use of a variety of techniques provided by the NLP to extract the answer from the passages. Specifically, the NLP tool tokenizes ontological terms and concepts from tables, and POS tag, and matches a variety of terms and concepts in text. The two most common approaches are the surface matching answer extraction and semantic type answer extraction. Surface matching simply identifies some terms in the retrieved passages and compares them to the terms in the question, resulting in limited success. This step will use a more intelligent approach that employs semantic parsing to answer the question by extracting the terms from the passages that support the answer type. Then, selected sentences/passages that contain correct answers are ranked to support answer selection process, which may select the sentence/passages with the highest rank. Appropriate metrics for calculating recall (the percentage of correct phrases identified) and precision (the percentage of identified phrases that are correct) can be used to measure the performance of the answer extraction process.

The software and method also comprises the implementation of a secure web portal. The four subtasks for the portal include: i) designing and developing the web server using PHP5 for web scripts and MySQL database management system to host company names and registered users; ii) linking the web server to the invention's corporate governance rating module; iii) installing the Globus Toolkit (a service-oriented infrastructure) and interface with the web server; iv) running series of penetration test to evaluate the vulnerability of the web server and document findings. The web server will be used to validate correct answers. The interface will consist of a scrollable list of the global 5,000 corporations. For example, the Globus Toolkit (a freeware from the Globus Foundation) provides the resources for launching web services with embedded security and networking requirements. The user will be able to connect to the portal by typing www.kaelo.com from a desktop or web-enabled cellular telephone or PDA, and request Kaelo score for a company of interest. When the user selects one of the companies, the system will display the rating score for each of the four governance areas and the composite score. The user can obtain the rationale behind the rating for each score by mouse clicking the name of the score.

The software and method can also comprise developing of a multi-agent system for social and network analysis. The six subtasks in the multi-agent system include: i) constructing committee members social networks from brief biographical description; ii) ascribing the roles and responsibilities of each committee member to their corresponding agents; iii) writing appropriate rules to match patterns to detect role commitment violations among the members; iv) testing the system for predictive accuracy and document findings; v) developing agent rules to implement trust network inference, Ding et. al. (2004) to demonstrate emergence interpretation of trust network inference (compared to graph theory and referral network interpretations) that enables agents to both discover and evolve trust knowledge using data of a known trust network of board members; and vi) finding documents.

The software and method can further comprise generating Corporate Governance Rating score. Using the information contained in the Answer Extraction Database, the process will generate a first set of indices and refine the indices within the Refined Governance Rating module as depicted in FIG. 2. Rule-based approximate reasoning and Constraint Satisfaction Analysis finalizes the indices. The rule-based engine will be based on fuzzy rule sets to resolve any ambiguities in the final score. Those rules will be used in situations or cases where the industry best practices questions do not provide exact matches with the information found in the corporation's SEC filings and other data repositories, or their interpretation may be constrained by other factors. The five subtasks will generate and evaluate the following indices: i) governance and ethics; ii) executive compensation; iii) auditing and accounting; iv) financial controls; and v) composite score.

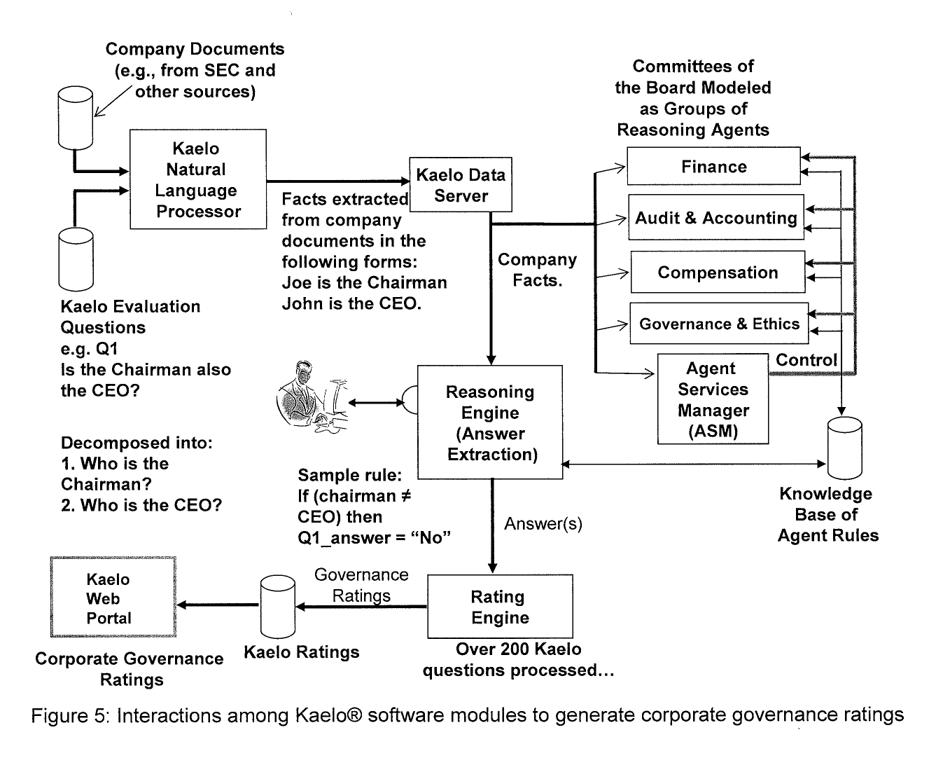

FIG. 5 depicts the interactions among software modules to generate corporate governance ratings. The process described in FIG. 5 is an implementation of the invention architecture depicted in FIG. 2. The diagram identifies the different software modules needed to generate ratings provided to users via the web portal described herein (bottom left). As shown in the interaction diagram, the Natural Language Processor (NLP) of the present invention accepts company documents and questions, processes them to generate relevant facts from the documents and deliver them to a data server. The data server forwards the facts to the reasoning engine for answer extraction. The ultimate goal of the reasoning engine is to automatically extract 100% of the answers. In certain situations where human assistance is need, a user interface to the reasoning engine is supported. The rating engine accepts the answers from the reasoning engine to generate the governance ratings. All of the processes for generating the ratings are done off-line to populate the ratings database of the invention. This permits the user to access and retrieve ratings on demand.

The invention further comprises the testing and validation of indices for the global 5,000 publicly traded corporations and organizations. This step also involves the determination of the measure of merit based on precision and recall. Recall is the proportion of known terms and concepts that Kaelo is able to extract from unstructured text, while Precision is the proportion of those terms that provide correct answers. The validation process will involve a manual analysis of a company's documents, generation of ratings, and comparison of those ratings with those generated by the system for a statistically selected sample of publicly traded companies.

The foregoing description of the present invention has been presented for the purpose of illustration and description. The description is not intended to limit the invention to the form disclosed herein. Consequently, variations and modifications commensurate with the above teachings, and the skill or knowledge of the relevant art are within the scope of the present invention. The embodiments described herein above are further intended to explain best modes known for practicing the invention and to enable others skilled in this art to utilize the invention in such, or other, embodiments and with various modifications required by the particular applications or uses of the present invention. It is intended that the appended claims be construed to include embodiments to the extent permitted by the prior art.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference in their entirety. More generally, documents or references are cited in this text, either in a Reference List before the claims; or in the text itself; and, each of these documents or references (“herein-cited references”), as well as each document or reference cited in each of the herein-cited references (including any manufacturer's specifications, instructions, etc.), is hereby expressly incorporated herein by reference in its entirety.

### REFERENCES

Aggarwal, R., & Williamson, R. (2006). Did New Regulations Target the Relevant Corporate Governance Attributes?, McDonough School of Business, Georgetown University, Washington DC 20057.
Bauer, R., Guenster, N., & Often, R. (2004). Empirical Evidence on Corporate Governance in Europe: The Effect on Stock Returns, Firm Value and Performance. Journal of Asset Management. Vol. 5, 2, 91-104.
Beth, T., Borcherding, M., & Klein, B. (1994). Valuation of trust in open networks, Proceedings of The European Symposium on Research in Computing Security [ESORICS], Brighton UK. Springer Verlag 1994, 3-18.
Bhagat, S., Bolton, B., & Romano, R. (2007). The Promise and Peril of Corporate Governance Indices. European Corporate Governance Institute. ECGI Working Paper Series in Law. No. 89/2007, www.ecgi.org/wp Paper downloaded from http://ssrn.com/abstract⁼1019921,
Bontcheva, K., Tablan, V., Maynard, D., & Cunningham, H. (2004). Evolving GATE to Meet New Challenges in Language Engineering. Natural Language Engineering. Cambridge University Press. http://dcs.shef.ac.uk.
Brown, L. D., & Caylor, M. L. (07/2004). Corporate Governance and Firm Performance. Georgia State University.
Caprasse, Jean-Nicolas. ISS and Deminor Rating: Meeting the needs of institutional investors in Europe and Globally, Institutional Shareholder Services, available at http://www.issproxy.com/global/europe.jsp
The Conference Board. (2005). Corporate Governance Handbook 2005: Developments in Best Practices, Compliance, and Legal Standards. Special Report SR-05-02. www.conference-board.org.
The Conference Board. (2003). The Conference Board Commission on Public Trust and Private Enterprise: Findings and Recommendations. Special Report SR-03-04. www.confrence-board.org.
CSLab. Cognitive Science Laboratory, “WordNet, a lexical database for the English language”, Princeton University. (http://wordnet.princeton.edu/)
Cunningham, H., (2004). Information Extraction, Automatic. Dept. of Computer Science, University of Sheffield, Sheffield, UK. http://dcs.shef.ac.uk.
Ding, L., Kolari, P., Ganjugunte, S., Finin, T.; & Josh, A. (2004). Modeling and Evaluating Trust Network Inference”, UMBC eBiquity Publications, July 2004. (http://ebiquity.umbe.edu/paper/html/id/170/).
Drobetz, W., Schillhofer, A., & Zimmermann, H. (2004). Corporate Governance and Expected Stock Returns: Evidence from Germany. European Financial Management, Vol. 10, No. 2, 267-293.
Golbeck, J., Parsia, B., & Hendler, J. (2003). Trust Networks on the Semantic Web, Proceedings of Cooperative Intelligent Agents, Helsinki, Finland, 2003.
Gompers, P. A., Ishii, J. L., & Metrick, A. (2003). Corporate Governance and Equity Prices. Quarterly Journal of Economics 118(1). Pp. 107-155.
Gompers, P., Ishii, J. & Metrick, A. (2003). Corporate Governance and Equity Prices. The Quarterly Journal of Economics, February 2003. 107-155.
Greenwood, M. A., (2005). Open-domain Question Answering. Ph.D. Thesis. Dept. of Computer Science, University of Sheffield, UK.
Hanneman, R., & Riddle, M. (2005). Introduction to social network methods, Riverside Calif., 2005. Digital version at (http://faculty.ucr.edu/⁻hanneman/)
Hoppner, F., Klawonn, F., Kruse, R., Runkler, T. (1999). Fuzzy Cluster Analysis. Wiley, Chichester.
Larcker, D. F, Richardson, S. A; & Tuna, I. A. (2005). How Important is Corporate Governance? Available at: http://ssrn.com/abstract⁼595821.
Litkowski, K. (2004). Syntactic Clues and Lexical Resources in Question-Answering. Workshop on Question-Answering in Restricted Domains, ACL 2004, Forum Convention Centre, Barcelona, Spain.
Molla, D., & Van Zaanen, M. (2005). AnswerFinder at TREC 2005.
Molla, D. & Vicedo, J. L. (2006). Question Answering in Restricted Domains: An Overview. Special Section on Restricted-Domain Question Answering. Association for Computational Lingusistics, 23 Oct. 2006.
Odubiyi, J. B., Wakim, N., Kocur, D., Weinstein, S. M., et. al. (1997). SAIRE—A Scalable Agent-based Information Retrieval Engine, Proceedings of the First International Conference on Autonomous Agents, 292-299, Marina del Rey, Calif., February 1997.
Romanek, B. & Lynn, D. (08/07). Commentary on GAO Report on Corporate Governance and Proxy Advisors: No Smoking Guns. TheCorporateCounsel.net Blog. The Practical Corporate & Securities Law Blog.
Scott, J. (2000). Social network analysis: a handbook, Sage Publications, 2000.
Shoham, Y. (1993). Agent-oriented programming. In M. Huhns & M. Singh (Eds.), Readings in agents 329-349. San Francisco: Morgan Kaufmann Publishers.
Soderland, S. (1999). Learning Information Extraction Rules for Semi-structured and Free Text. Machine Learning, Kluwer Academic Publishers, The Netherlands Vol. 34, 233-272.
Sole, R. & Serra, J. (2002). NetExpert: Agent-based Expertise Location by Means of Social and Knowledge Networks. In Knowledge Management and Organizational Memories, ch 14, pp. 159-168, Kluwer Academic Publishers (2002).
Sonnenfeld, J. (2004). Good Governance and the Misleading Myths of Bad Metrics, 18 Academy of Management Executives., No 1.
Srihari, R. & Li, W. (2004). A Question Answering System Supported by Information Extraction. Cymfony Inc., Williamsville, N.Y. 14221.
Tellex, S., Katz, B., Lin, J., Fernandes, A., & Marton, G. (2003). Quantitative Evaluation of Passage Retrieval Algorithms for Question Answering. Proceedings of the 26^{th} Annual International ACM SIGIR Conference on Research and Development in Information Retrieval (SIGIR 2003), July 2003, Toronto, Canada.
United States Government Accountability Office. (June 2007). Corporate Shareholder Meetings. Issues Relating to Firms That Advise Institutional Investors on Proxy Voting. GAO-07-765.
Voorhees, E. M.; & Dang, H. R. (2006). Overview of TREC 2005 Question Answering Track. National Institute of Standards and Technology, Gaithersburg, Md. 20899.
Voorhees, E. M. (2005). Overview of TREC 2004 Question Answering Track. National Institute of Standards and Technology, Gaithersburg, Md. 20899.
Ziegler, C., & Lausen, G. (2004). Spreading activation models for trust networks, Proceedings of the IEEE International Conference on e-Technology, e-Commerce, and eService, Taipei, Taiwan, IEEE Computer Society Press, 2004.

1. A method and system for rating companies comprising: precompiling natural language questions, automatically generating corporate governance ratings of the leadership team of publicly traded companies, analyzing said precompiled natural language questions, extracting answers from a database of publicly available structured and unstructured texts of official documents of public companies.

2. The method of claim 1, further comprising: acquiring a set of leadership principles, wherein said set of leadership principles comprise best leadership practices and governance factors for publicly traded companies.

3. The method of claim 2, wherein said governance factors comprise compensation data, auditing data, accounting data, and foreign data.

4. The method of claim 1, wherein said database of publically available structured and unstructured lists comprise SEC filings.

5. The method of claim 4, further comprising during said data from sources of information.

6. The method of claim 1, comprising: developing a smart source finder, wherein said source finder develops an autonomous agent software program employing a list of candidate data sources.

7. The method of claim 6, wherein said list of candidate data services are stored locally and remotely.

8. The method of claim 6, wherein said service manager module comprises defining a best data subset.

9. The method of claim 6, wherein said since manager module comprises maintaining an up-to-date knowledge base of sciences and patent descriptions.

10. The method of claim 9, wherein said services of information comprise SEC filings, company websites, investor relations documents, white pages, online publications, newspapers, magazines and journals.

11. The method of claim 1, comprising: processing said official documents which determine the type of document, and extracting the text content by converting many formats into a common format.

12. The method of claim 1, comprising: avoiding incorrect categorization of the questions and preventing correct answer extraction by categorizing precompiled domain-specific questions into coarse grained and fine grained question classes.

13. The method of claim 12, wherein said extracting further comprises identifying basic entities with said official documents for further analysis.

14. The method of claim 13, wherein said coarse grained classes comprise six categories of question types: ABBREVIATION, DESCRIPTION, ENTITY, HUMAN, LOCATION, and NUMERIC.

15. The method of claim 13, wherein said coarse grained classes comprise six categories of question types: ABBREVIATION, DESCRIPTION, ENTITY, HUMAN, LOCATION, and NUMERIC (Greenwood 2005).

16. The method of claim 13, further comprising decompressing said questions into question components and reformulating said question components into definition questions.

17. The method of claim 1, further comprising: processing questions step comprising annotating said questions using a Natural Language Processing (NLP) tool, tokenizing POS (parts of speech) and tagging and syntactically and semantically parse the question.

18. The method of claim 1, further comprising: retrieving passages that contain relevant answers to corresponding questions, wherein said passages provide or contribute to the answer.

19. The method of claim 18, wherein said retrieving passages further comprising connecting terms in said questions with related terms in the unstructured texts.

20. The method of claim 19, wherein said retrieving passages further comprise inferring context in chunked text passages using said NLP tools to identify sentence fragments and domain ontology to resolve specialized technologies.

21. The method of claim 7, wherein said extracting answers further comprises using the NLP to select said passages that provides the most correct answer to the question, wherein said extracting further comprises tagging parts of speech (POS) using the NLP in the question and match a variety of terms and concepts in the question with those in the retrieved passages to generate a list of sentences or passages that contain the answers.

22. The method of claim 1, comprising: developing and deploying a web portal delivering corporate governance rating indices to the user via the web portal.

23. The method of claim 1, comprising: constructing a company member's social network from said passages further comprising brief biographical description structured text, demonstrating said member's social network for knowledge discovery, and storing results in the answer extraction knowledge base.

24. The method of claim 1, comprising: using the answer in an Answer Extraction Database and the initial corporate governance rating method to generate a first set of corporate governance rating indices, generating a rating for each of four governance areas and a composite for each company.

25. The method of claim 1, comprising: refining corporate governance ratings to produce corporate leadership performance ratings in the four areas of interest (i.e., governance and ethics, executive compensation, auditing and accounting, and financial controls), and generating a composite score from a weighted computation of the indices from the four governance areas.

26. The method of claim 23, wherein said constructing companies modeling said company mentors roles, responsibilities, social networks and role commitment violations using a multi-agent system.
